(19) United States
(12) Patent Application Publication
(10) Pub. No.: US 2007/0244835 A1
(43) Pub. Date: Oct. 18, 2007

(54) Web-Accessible Financial Product Sales Assistance System and Method

(75) Inventor: Frederick A. Henry, Mequon, WI (US)

Correspondence Address: REINHART BOERNER VAN DEUREN P.C., 2215 PERRYGREEN WAY, ROCKFORD, IL, 61107, US

(73) Assignee: FIMSA, LLC, Mequon, WI (US)

(21) Appl. No.: 11/688,963

(22) Filed: Mar. 21, 2007

Related U.S. Application Data
(63) Continuation-in-part of application No. 11/412,281, filed on Apr. 27, 2006.
(60) Provisional application No. 60/893,727, filed on Mar. 8, 2007.
(60) Provisional application No. 60/744,963, filed on Apr. 17, 2006.

(51) Int. Cl. G06Q 40/00

(52) U.S. Cl. 705/36 R

(57) ABSTRACT

An interactive web-accessible financial product sales assistant system and method is disclosed that facilitates the sale of financial products such as annuities by providing prompts to agents accessing the system to obtain and enter all financial product sales information required by the providers of the financial products in order to place applications for the financial products in good order. The agents use the sales assistant system as an entry pad while taking customer information, with the system immediately noting incorrect or inappropriate entries, thereby making the sale process more efficient. The system runs a full check of the sales order when completed by the agent, and any errors are immediately bought to the attention of the agent so that they can be corrected. A reviewer can approve, request rework, or reject a sales order. Once approved, the annuity or other financial product may be purchased from the financial product provider.

### CROSS-REFERENCE TO RELATED APPLICATION

This patent application is a continuation-in-part of co-pending U.S. patent application Ser. No. 11/412,281, filed on Apr. 27, 2006, which claims priority of U.S. Provisional Patent Application No. 60/744,963, which is entitled “Web-Accessible Financial Product Sales Assistance System and Method,” and which was filed on Apr. 17, 2006, which provisional patent application is hereby incorporated herein by reference in its entirety. This patent application also claims priority to U.S. Provisional Patent Application No. 60/893,727, filed Mar. 8, 2007, which provisional patent application is hereby incorporated herein by reference in its entirety.

### BACKGROUND

The present technology relates generally to systems and tools for use in conjunction with the sale of financial products such as annuities, and more particularly to an improved interactive web-accessible financial product sales assistance system and method for facilitating the sale of financial products by providing prompts to agents accessing the system to obtain the direct online entry of all financial product sales information required by the providers of the financial products in order to place applications for the financial products in good order.

With an ever-increasing number of people having expectations of a relatively long period of retirement together with an awareness of the need to exercise careful financial planning for such a prolonged period of retirement, it has become progressively more important to ensure that retirees do not outlive their assets. For many searching for financial products upon which they can depend in retirement, annuities have become the desired financial product with which to supplement Social Security and other more traditional financial arrangements. Simply stated, annuities are agreements under which the seller of the annuity (typically a life insurance company, trust, or charity) contractually agrees to pay the buyer of the annuity a series or stream of payments. Annuities are especially desirable as retirement investment vehicles inasmuch as investment earnings in the annuities—capital gains and investment income—are not taxable until the money is withdrawn from the annuity.

Annuities can be purchased through a variety of parties, including banks, life insurance carriers, financial planners, and insurance agents, although annuity policies are issued only by life insurance companies. The sellers of annuities fall into two categories, the first of which is banks and brokerage firms, and the second of which is independent agencies. Products developed by life insurance companies are often marketed through banks and stock brokerage firms. If an annuity is purchased through a bank or brokerage firm, the buyer will typically deal with an agent who is an employee of the bank or brokerage firm and who is a licensed life insurance agent (and, in the case of variable annuities, a registered securities representative). If the annuity is purchased through an agency, the agent(s) at the agency will also be licensed, and may represent either a single insurance company or multiple companies.

While annuities are relatively simple in concept, the process of selling an annuity is extraordinarily complex. The paperwork which must be completed by the agent in order to complete the sale of the annuity is both long and relatively complex, and it requires a large amount of information to be obtained from the purchaser of the annuity. If the proper information is not presented to the insurance company selling the annuity, the insurance company will not validate the annuity, and this can present a problem, particularly if the terms of the annuity product change between the time the paperwork is improperly completed and the time that the error(s) is (are) corrected. Since any given agent may sell a wide variety of annuity products from a number of different insurance companies, it is to be expected that the paperwork varies considerably both with different types of annuities and with different insurance companies, and agents thus typically must deal with dozens of different types of paperwork in the course of selling the annuity products offered by their bank or agency.

In addition, agents, who are typically paid at least in part based upon commissions which may be received periodically (e.g., monthly) may have to wait an entire month to be paid if they have missed a periodic cutoff for commissions. Further, the banks or agencies for which the agents work typically receive fee income from the insurance companies selling the annuities on the same periodic basis, and it will thus be appreciated that it is quite important to the banks and agencies that the paperwork be properly filled out at the time of the initial sale of the annuity. Also, incorrect and/or incomplete paperwork may necessitate the agent going back to the buyer for additional information or signatures, potentially damaging the reputation of the agent and/or bank or agency in the buyer's eyes. For this reason, an elite financial specialty which has developed is the annuity order facilitator which stands between the agent meeting with the purchaser of the annuity and the insurance company selling the annuity.

The banks and agencies which sell annuities, in recognition of the importance of the fee income from selling the annuity products, now deal with financial transaction solution providers (such as the assignee of the present patent) to ensure that the orders for annuities are properly completed prior to their submission to the insurance companies selling the annuities. Such financial transaction solution providers offer effective sales training to the agents who are employees of the financial transaction solution providers' bank and agency clients, help the banks and agencies select appropriate annuity investment products, and provide ongoing support to banks and agencies of every size which desire to offer annuity products to their customers. In so doing, the financial transaction solution providers build mutually profitable long-term working relationships with their bank and agency clients.

The presently preferred method of servicing the large numbers of agents from banks and agencies selling annuities and other similar financial products offered by a large number of different insurance companies is through the use of a call center. Under this method, the agents call or fax in sales information after they have made a sale and a call center employee takes the information and enters it into a computer program designed for this purpose. Once all of the necessary information for the sale of an annuity or other financial product has been entered into the computer program by the call center employee, the sale is then deemed to be “in good order,” and the annuity or other financial product is purchased.

The call center employee typically has a data entry screen with many pop-up windows which request the appropriate information in a particular order. The pop-up windows are completely scripted and are dynamically based upon the particular annuity or other financial product which is being purchased. There is both a large amount and a wide variety of information which must be provided, and in many cases the agents do not have all of the needed information during the initial call, necessitating one or more follow-up calls with the call center. The call center employee thus prompts the agents for all of the information which is required for the purchase of the annuity or other financial product, thereby ensuring that when the order is submitted to the insurance company selling the annuity that the annuity purchase will be “in good order,” thereby enabling the expeditious purchase of the annuity or other financial product.

It may be appreciated that the services provided by financial transaction solution providers are invaluable to banks and agencies selling annuities and similar financial products. However, this service is not without cost, since it will be appreciated by those skilled in the art that a call center employee must spend time on making sure that the annuity purchase is “in good order,” and this practice is somewhat labor-intensive, requiring at least between three and thirty minutes of assistance per annuity purchase.

A brief review of the efforts of others in this area is also instructive. U.S. Pat. No. 6,856,679, to Pennington, Jr. et al., discloses a system and method to provide automated, end-to-end scripting to guide a customer service representative in handling a call from a customer. U.S. Patent Application Publication No. 2004/0044561, to Kolb et al., discloses a commercial vehicle customer economic value tool which directs a sales representative of commercial vehicles to query a customer and input salient information about the customer.

U.S. Pat. No. 6,826,745 and U.S. Patent Application Publication No. 2005/0086220, both to Coker et al., disclose a system and method for smart scripting call centers which uses scripts having hierarchical sets of structured pages. U.S. Pat. No. 6,581,067, to Bjergo et al., discloses a system and method for providing administrative support to customer service representatives. U.S. Patent Application Publication No. 2004/0158481, to Gennaro et al., discloses systems and methods for sales territory whitespacing. U.S. Patent Application Publication No. 2002/0156701, to Fultz, discloses an automated sales system for the moving and storage industry. However, none of these references provide an improvement to the financial transaction solution provider's call centers mentioned above.

### SUMMARY

The present invention overcomes one or more of the disadvantages and limitations of the background art discussed above. With this invention, an Internet-accessible software-operated system is provided which enables agents employed by banks and agencies to directly enter annuity sales order information by logging onto a secure website and providing the information directly via the website more efficiently and at a lower cost than call centers. The website may be thought of as providing a series of online smart forms which will walk the selling agent through entry of all of the necessary information. The system includes a principal review dashboard that enables distributors to maintain regulatory compliance and ensure adherence to specific transaction standards.

The system and method of the present invention provides similar services to agents of banks and agencies selling annuities and other similar financial products to those currently provided by financial transaction solution provider's call centers to place orders for the annuities and other similar financial products “in good order,” but more efficiently and at a lower cost. It is capable of being integrated with an existing call center operation to service agents of banks and agencies which desire to continue using a call center at least in part.

The system and method of the present invention is simple to use by the agents who are employees of the banks and agencies selling annuities and other similar financial products and it should maximize efficiency and minimize cost in the selling and ordering of annuities and other similar financial products.

The system and method of the present invention can be tailored to reflect the various distributor's criteria. An agent's or sales representative's transmitted sale can be tested against those criteria for approval prior to being submitted to a carrier.

The web-accessible financial product sales assistance system and method of the present invention should be relatively straightforward to implement by a financial transaction solution provider while providing agents of banks or agencies selling annuities and other similar financial products with highly reliable operation which is always available. In order to enhance the market appeal of the web-accessible financial product sales assistance system and method of the present invention, it should be as economically beneficial as possible to its bank and agency customers to thereby afford it the broadest possible market. Finally, it is also an objective that all of the aforementioned advantages and objectives of the web-accessible financial product sales assistance system and method be achieved without incurring any substantial relative disadvantage.

The agent can use the website as an entry pad to be used while taking the information from the customer. The web-accessible financial product sales assistance system and method of the present invention thus provides screens and guides the agent through the entry of customer information including information relating to the suitability of various annuities and other financial products, the selection of a wide variety of products, the entry of all necessary policy information, and even the entry of the source of funding for the annuity or other financial product.

Since the web-accessible financial product sales assistance system prompts the agent or sales representative for all necessary information as well as immediately noting incorrect or inappropriate entries, the sale process will become more efficient. The web-accessible financial product sales assistance system also runs a full check of the sales order when completed by the agent and prior to sending it to the financial product provider. If there are any errors, they are immediately bought to the attention of the agent so that they can be corrected, following which the sales order is forwarded to the financial product provider for purchase of the annuity or other financial product.

The web-accessible financial product sales assistance system determines whether a transmitted application must be reviewed by a Principal Review Desk/Trade Review Desk based on established business rules of the particular distributor that handles the transmitted application. If a review is called for, a reviewer calls up the images of the documents associated with the application via a secure log-in to review them. The agent can make changes and resubmit the application if a rework is needed.

Other features provided in the preferred embodiment are of assistance to the sales representatives in selling the financial products, and include complete online application information queries, a complete list of the financial products available and the details relating thereto, information relating to how the financial product will be funded, note entry areas, a wide variety of reports, and a database of financial products previously sold by the representatives, as well as previous customers, etc. It will be appreciated that the call center employees are largely eliminated (only a help line is necessary), resulting in a reduction in costs, as well as automating the system and making it available at any time rather than only during normal business hours.

It may therefore be seen that the present invention provides a web-accessible financial product sales assistance system and method that provides a service to agents of banks and agencies selling annuities and other similar financial products that is similar to the service provided by financial transaction solution provider's call centers to place orders for the annuities and other similar financial products “in good order,” but more efficiently and at a lower cost. The web-accessible financial product sales assistance system and method of the present invention uses the Internet to provide a web-accessible financial product sales assistance system and method to perform the function currently performed by call center employees. The web-accessible financial product sales assistance system and method of the present invention is also capable of being integrated with an existing call center operation to service agents of banks and agencies which desire to continue using a call center at least in part.

The web-accessible financial product sales assistance system and method of the present invention is capable of working with any and all of the wide variety of annuities and like financial products available. The web-accessible financial product sales assistance system and method of the present invention is simple to use by agents who are employees of the banks and agencies selling annuities and other similar financial products. The web-accessible financial product sales assistance system and method of the present invention maximizes efficiency and minimizes cost in the selling and ordering of annuities and other similar financial products.

The web-accessible financial product sales assistance system and method of the present invention is relatively straightforward to implement by a financial transaction solution provider, and provides agents of banks or agencies selling annuities and other similar financial products with a highly reliable operation which is always available. The web-accessible financial product sales assistance system and method is as economically beneficial as possible to its bank and agency customers to enhance its market appeal and to thereby afford it the broadest possible market. Finally, all of the aforementioned advantages and objectives of the web-accessible financial product sales assistance system and method are achieved without incurring any substantial relative disadvantage.

### DESCRIPTION OF THE DRAWINGS

These and other advantages of the present invention are best understood with reference to the drawings, in which:

FIG. 1 is a functional schematic diagram showing an implementation of the web-accessible financial product sales assistance system of the present invention;

FIG. 2 is a flow diagram depicting the operation of the web-accessible financial product sales assistance system of the present invention illustrated in FIG. 1;

FIG. 3 is a screen shot of a login screen which an agent can use to log into the web-accessible financial product sales assistance system of the present invention;

FIG. 4 is a screen shot showing the existing transactions on the web-accessible financial product sales assistance system of the present invention for a particular agent;

FIG. 5 is a screen shot of a screen which an agent can use to select a cost center or branch name for his/her bank or agency;

FIG. 6 is a screen shot of a screen which would be used instead of the screen shot shown in FIG. 5 if the user is at a call center and is assisting an agent who is unable to access the web-accessible financial product sales assistance system and method of the present invention directly;

FIG. 7 is a screen shot of a screen which an agent can use to indicate whether the sale is a new sale (a new customer) or an addition to an existing annuity or other financial product;

FIG. 8 is a screen shot of a screen which an agent can use to enter personal information for a new customer purchasing a first annuity or other financial product;

FIG. 9 is a screen shot of a screen which an agent can use to enter information relating to the suitability of the annuity or other financial product for the particular customer;

FIG. 10 is a screen shot of a screen which an agent can use to select a particular annuity or other financial product to be sold to a customer;

FIG. 11 is a screen shot of a screen which an agent can use to enter detailed information necessary for the purchase of the selected annuity or other financial product;

FIG. 12 is a screen shot of a screen which an agent can use to provide information relating to the source of funds to purchase the annuity or other financial product;

FIG. 13 is a screen shot of a screen which an agent can use to view information regarding a customer to whom an additional annuity or other financial product is being sold;

FIG. 14 is a screen shot of a screen which an agent can use to enter notes relating to the particular customer or the sale of the annuity or other financial product to that customer;

FIG. 15 is a screen shot of a screen of part of a principal review dashboard;

FIG. 16a is a screen shot of a partial screen for creating a rule;

FIG. 16b is a screen shot of a partial screen for creating a rule;

FIG. 17 is a screen shot of a screen which can be used to add a Principal Review Desk/Trade Review Desk user;

FIG. 18 is a screen shot of an example of a rule execution log;

FIG. 19 is a screen shot of an example of a workflow log;

FIG. 20 is a flow diagram depicting the steps a reviewer can take using the web-accessible financial product sales assistance system of the present invention;

FIG. 21 is a screen shot illustrating an example of a visual indicator that indicates a transaction has been put on hold;

FIG. 22 is a screen shot of a screen in which a reviewer can add a note for other reviewers;

FIG. 23 is a screen shot of a screen in which a reviewer can add notes for her own use;

FIG. 24 is a screen shot of a screen in which a reviewer can send a note to an agent for a transaction that needs rework;

FIG. 25 is a screen shot of a screen that a representative can use to see if pending transactions have been transmitted, need rework, or have been rejected;

FIG. 26 is a screen shot of a screen in which a representative can enter a note for a reviewer;

FIG. 27 is a screen shot of a dashboard that indicates pending transactions that are awaiting review;

FIG. 28 is a screen shot of a screen that can be used to show a history of a transaction;

FIG. 29 is a screen shot of a screen in which a reviewer can use to add a note to a rejection of a transaction;

FIG. 30 is a screen shot of a screen of a dashboard indicating transactions in review queues;

FIG. 31 is a screen shot of a screen of a dashboard that illustrates a transaction has moved from one review team to a queue of another team;

FIG. 32 is a screen shot of a screen in which basic searches may be performed;

FIG. 33 is a screen shot of a screen in which advanced searches may be performed;

FIG. 34 is a screen shot of a search results screen;

FIG. 35 is a screen shot of a screen illustrating that a searcher can return to prior search results;

FIG. 36 is a screen shot of a screen illustrating a search run on a representative's last name; and

FIG. 37 is a flow diagram depicting the steps taken to provide a credit to a bank or agency client.

### DETAILED DESCRIPTION

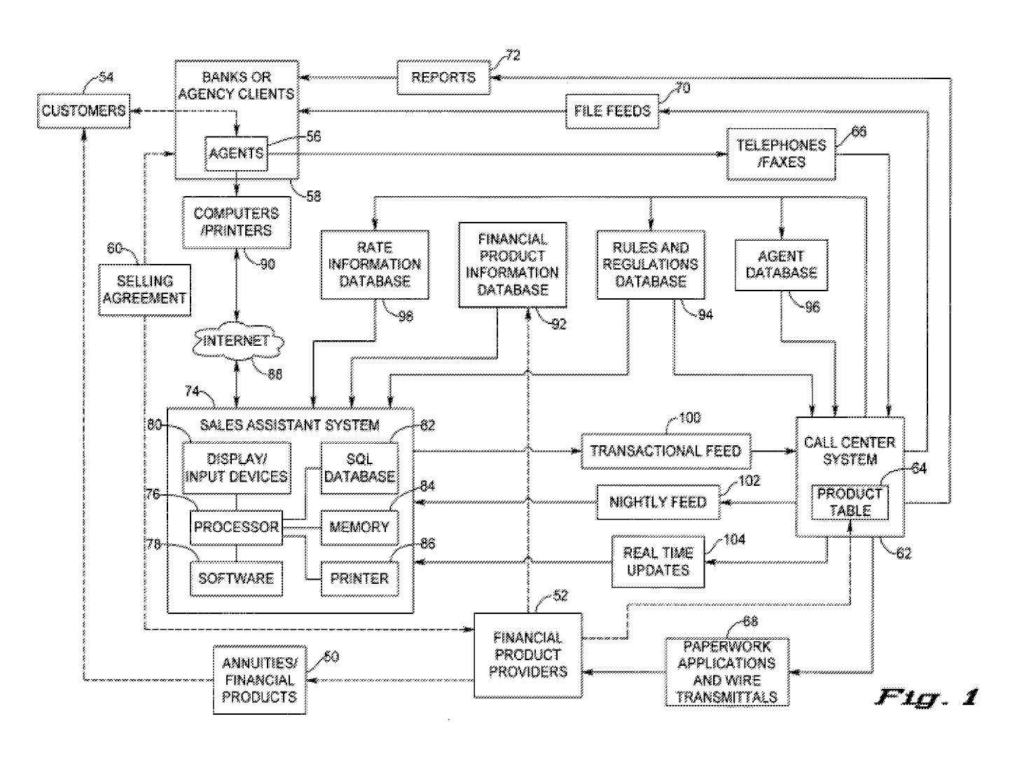

One embodiment of the web-accessible financial product sales assistance system and method of the present invention is illustrated by way of example in FIG. 1, which depicts the participants as well as the principal components of the web-accessible financial product sales assistance system itself. Historically, annuities or like financial products 50 have been sold by financial product providers 52 to customers 54. Often, the annuities or like financial products 50 are sold by agents 56, who are typically employees of banks or agency clients 58 which have selling agreements 60 with the financial product providers 52.

The web-accessible financial product sales assistance system and method of the present invention adds several primary components and a number of secondary components. The first primary component is a call center system 62, which interacts between the financial product providers 52 on the one hand and the agents 56 and the banks or agency clients 58 on the other hand. The call center system 62 has a product table 64 which includes information about all of the annuities and other like financial products which are offered by the financial product providers 52. Information is provided by the financial product providers 52 to the product table 64 at the call center system 62 on an ongoing basis so that the product table 64 always remains current.

The call center system 62 may be used by the agents 56 to place orders for the annuities or other financial products. The agents 56 provide information regarding new sales of annuities or other financial products to the call center system 62 by telephones or faxes 66. The call center employees in the call center system 62 process orders for new sales of annuities or other financial products, and when they are “in good order” the call center system 62 sends the orders to the financial product providers 52 as paperwork applications and wire transmittals 68 (the paperwork applications are all the paperwork that the financial product providers 52 require, and the wire transmittals are the funds for the new annuities or other financial products which have been sold). In an alternate embodiment, the orders are sent electronically over a secure connection to the financial product providers 52.

The call center system 62 provides a variety of information to the banks or agency clients 58. Specifically, the call center system 62 provides file feeds 70 to the banks or agency clients 58, typically on a daily basis. Alternately, the file feeds 70 may be more frequent updates, and they may optionally be real-time updates. The call center system 62 also provides a variety of reports 72 to the banks or agency clients 58, typically on an as-requested basis.

The second primary component of the web-accessible financial product sales assistance system and method of the present invention is a sales assistant system 74, which interacts with the call center system 62 as well as (and most notably) with the agents 56. The sales assistant system 74 is an entirely automated system which includes a processor 76 which operates using software 78 and is operatively connected to display/input devices 80, a SQL database 82 (which is used to store operational information such as information relating to orders and sales of annuities and other financial products), a memory 84, and a printer 86.

The memory 84 may be volatile (such as RAM), non-volatile (such as ROM, flash memory, etc.) or some combination of the two. Additionally, the sales assistant system 74 may also have additional features/functionality. The sales assistant system 74 may also include additional storage (removable and/or non-removable) including, but not limited to, magnetic or optical disks or tapes. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the sales assistant system 74.

The sales assistant system 74 may also contain one or more communications connections that allow the system to communicate with other devices. The communications connections are an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

The sales assistant system 74 is accessed by the agents 56 via a network such as the Internet 88 using computers/printers 90. The sales assistant system 74 also utilizes data from several external databases, one of which is a financial product information database 92 which includes information provided by the financial product providers 52 regarding all of the annuities and other similar financial products which are offered by the financial product providers 52. The financial product information database 92 is updated on an ongoing basis by the financial product providers 52 so that the financial product information database 92 always remains current. Additionally, the financial product information database 92 may include information that allows the agents 56 to automatically fill in portions of forms used to order products in the financial product information database 92.

A rules and regulations database 94 is used to provide basic rules and regulation information (information, guidelines, and restrictions related to the selling of annuities and other financial products) to ensure that all sales of annuities and other financial products will meet with all applicable rules and regulations. The rules and regulations database 94 may be updated by the call center system 62, and information contained therein is utilized by both the sales assistant system 74 and the call center system 62. An agent database 96 is used to provide current information regarding the agents 56, including which of the agents 56 are able to sell and in what states they are licensed, as well as other pertinent information. The agent database 96 may also be updated by the call center system 62, and information contained therein is utilized by both the sales assistant system 74 and the call center system 62.

A rate information database 98 is used to provide information regarding the various rates which are utilized in the sale of annuities and other financial products. The rate information database 98 may be updated by the call center system 62, and information contained therein is utilized by the sales assistant system 74.

The sales assistant system 74 provides a transactional feed 100 to the call center system 62 on an ongoing basis as transactions are processed by the sales assistant system 74. The call center system 62 provides at least a nightly feed 102 of information to the sales assistant system 74, and in one embodiment also provides real-time updates 104 to the sales assistant system 74.

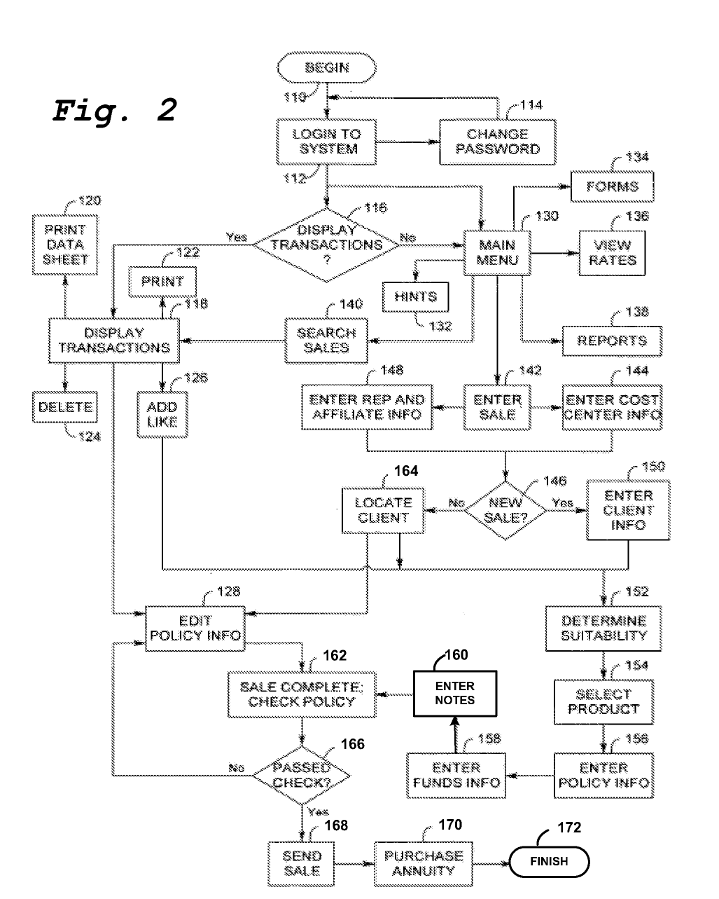

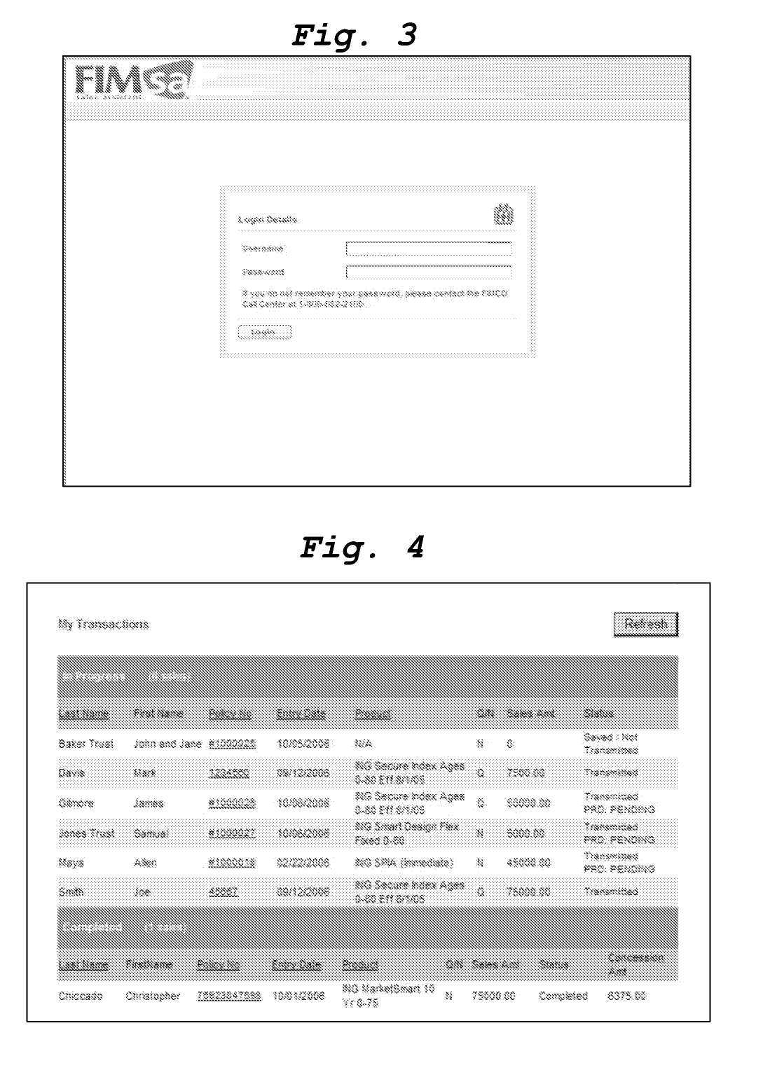

Referring next to FIG. 2, a flow diagram is shown which presents the operation of the web-accessible financial product sales assistance system and method illustrated in FIG. 1. The sales assistant system 74 is accessed by the agent 56 through the use of the computers/printers 90 (also illustrated in FIG. 1). The following discussion of the operation of the web-accessible financial product sales assistance system and method will also make reference to screen shots shown in FIGS. 3 through 14. The process begins with a process initiation step 100, and moves initially to a login to system step 112 during which the screen shown in FIG. 3 will be displayed to the agent 56.

The agent 56 (shown in FIG. 1) enters his/her username or ID and password, and the sales assistant system 74 (also shown together with its components in FIG. 1) will check these data entries against records stored in the SQL database 82. It may be noted that the information from the agent database 96 is provided by the call center system 62 to the sales assistant system 74, where it is stored in the SQL database 82. If the username and password entered by the agent 56 is correct, the sales assistant system 74 will log the agent 56 on.

If the username and password entered by the agent 56 is incorrect, the sales assistant system 74 will deny the agent 56 access to the sales assistant system 74. In this case, the agent 56 will have to call the call center system 62 for access to the sales assistant system 74. If the password of the agent 56 has expired, the system will move to a change password step 114 in which the agent 56 is prompted to select a new password. Following logon, the agent 56 may optionally have an opportunity to change the password even though it has not expired if he/she wishes to do so in the change password step 114.

Following login, the agent 56 may opt to view his/her previous transactions in a display transactions determination step 11 6. If the agent 56 elects to view his/her previous transactions, the process moves to a display transactions step 118 in which the previous transactions of the agent 56 may be viewed. This is illustrated in the screen shown in FIG. 4. From the display transactions step 118, the agent 56 has four principal options which may be selected.

A data sheet for a selected previous transaction may be printed in a print data sheet step 120. Alternately, the details of the entire selected transaction may be printed in a print transaction step 122. Since the transactions displayed may include transactions which are not yet complete, there are two additional options which may be selected. A transaction which is not complete may be deleted in a delete transaction step 124. There is an add like step 126 which may be used to add an additional sale of an annuity or other financial product which is similar to a previously transmitted sale. Finally, there is an edit policy information step 128 which may be used to edit an unfinished sale of an annuity or other financial product which was begun earlier but not completed or rework a previously submitted transaction that was tagged for rework. The steps which follow these last two steps will be discussed at a later point herein.

Returning to the display transactions determination step 116, if, on the other hand, the agent 56 does not elect to view his/her previous transactions, the process moves instead to a display main menu step 130. From the display main menu step 130, the agent 56 has six principal options which may be selected. At any time, the agent 56 may select a hints step 132 which will automatically provide the agent 56 with context-sensitive assistance. A display forms step 134 may be used to allow the agent 56 to view any of the forms which are associated with the various annuities or financial products which are available for the agent 56 to sell.

A view rates step 136 may be used to allow the agent 56 to view any of the current rates which are applicable to the various annuities or financial products which are available for the agent 56 to sell. The rate information is provided by the rate information database 98 (illustrated in FIG. 1) to the sales assistant system 74 (also illustrated in FIG. 1). An access reports step 138 may be used to allow the agent 56 to view and/or print any of a variety of reports which are relevant to the activities of the agent 56. It may also be noted that the banks or agency clients 58 also are able to print reports which are applicable to the sales of their agents 56.

Another option which is available to the agent 56 is a search sales step 140, wherein the agent 56 can enter data and locate transactions which contain the data entered. From the search sales step 140, the process will move to the display transactions step 118 wherein the transactions fitting the search criteria may be viewed by the agent 56. The final option which is available to the agent 56, and the most important of the options available from the display main menu step 130, is an enter sale step 142 in which the agent 56 begins the process of selling an annuity or other financial product.

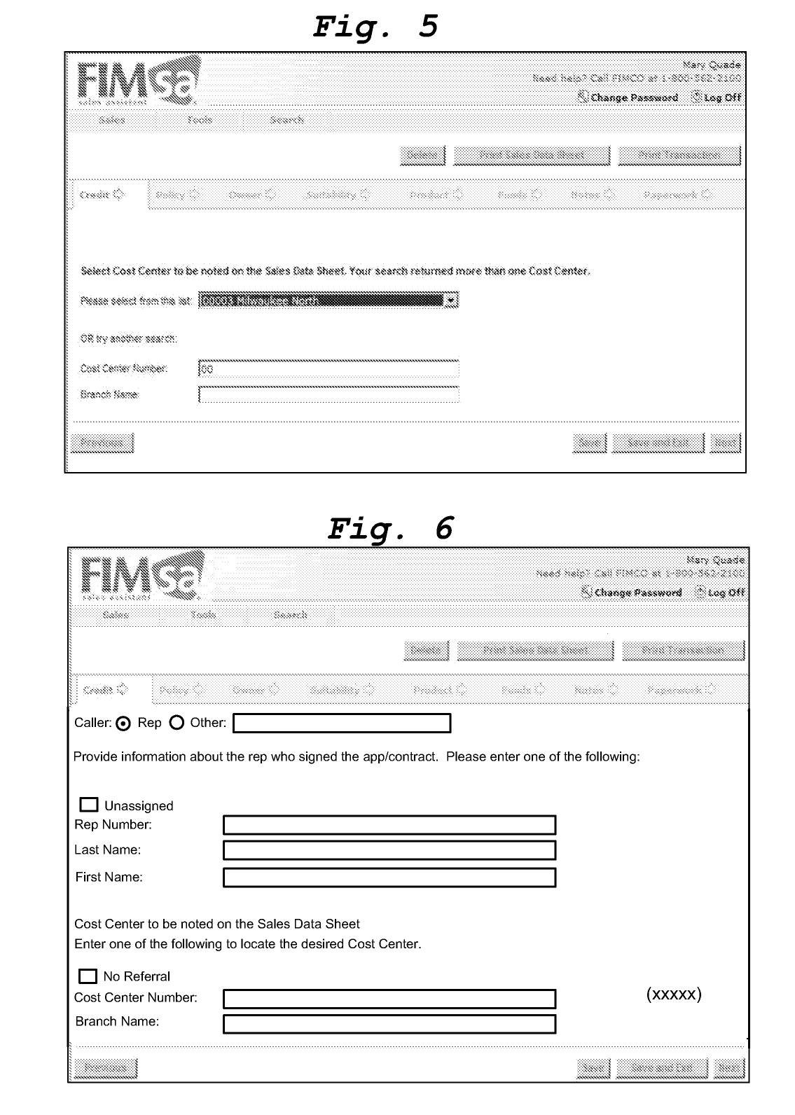

Once the agent 56 has selected the enter sale step 142, the process moves to an enter cost center information step 144 in which the agent 56 can enter a cost center or branch name which is the entity on behalf of which the agent 56 is selling the annuity or other financial product. This step is illustrated in the screen shown in FIG. 5. This step is necessary from an accounting standpoint to ensure that the credit for the sale is attributed to the proper cost center or branch.

Once the agent 56 has entered the cost center or branch, the process will move to a new sale determination step 146. In passing, it should be noted that in the event the agent 56 cannot access the sales assistant system 74 for some reason, the agent 56 may also call the sale in to the call center system 62 (illustrated in FIG. 1). In this event, an employee of the call center system 62 will perform an analog to the enter cost center information step 144. In an enter rep and affiliate step 148, the employee of the call center system 62 will enter the information for the sale of the annuity or other financial product, beginning with the screen shown in FIG. 6. This process would begin with the employee of the call center system 62 entering the name of the agent 56, and the cost center or branch name on behalf of which the agent 56 is selling the annuity or other financial product. Following this step, the process would move to the new sale determination step 146.

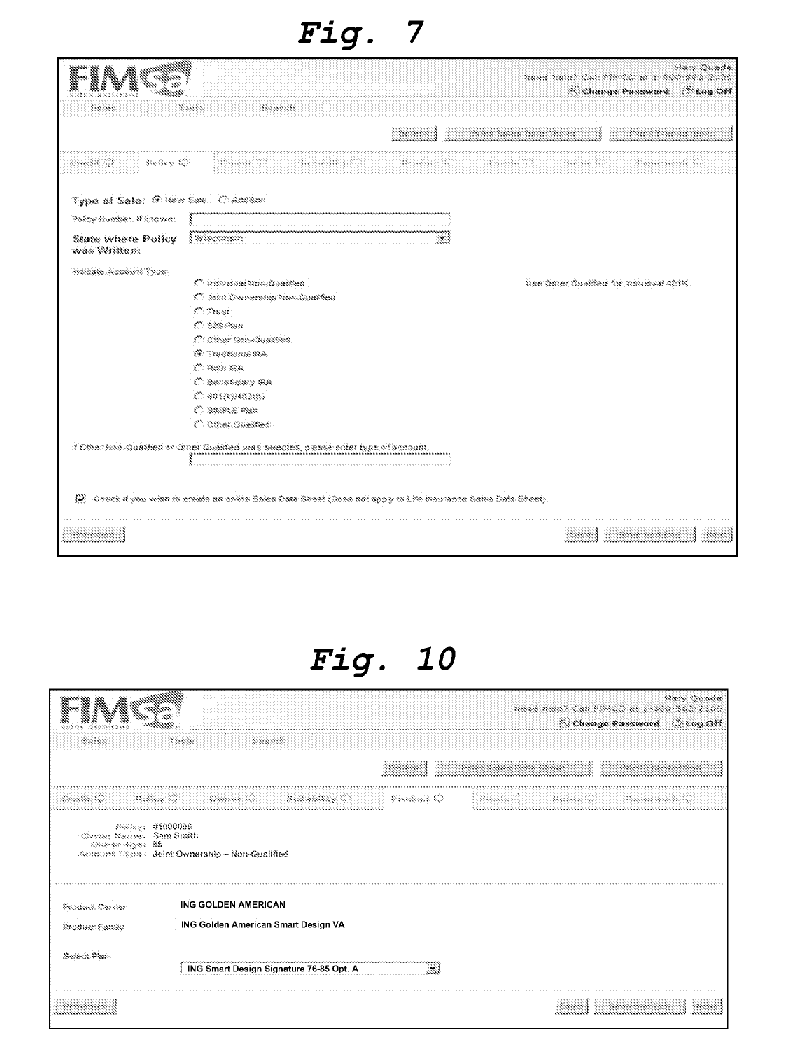

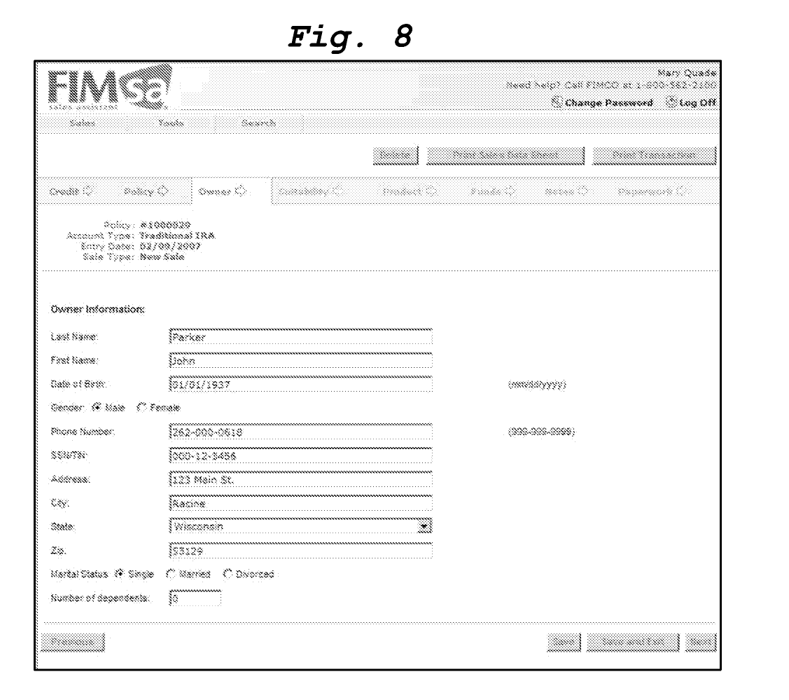

In the new sale determination step 146, the agent 56 will view a screen like the one shown in FIG. 7, and will have the opportunity to indicate whether the sale is a new sale or an additional sale (a sale being made to a customer to whom an annuity or other financial product was previously sold). If the agent 56 indicates that the sale is a new sale, the agent 56 may also add information including the policy number if known, the state where the policy is being written, and the account type (e.g., individual non-qualified, joint ownership non-qualified, trust, 529 plan, other non-qualified, traditional IRA, Roth IRA, beneficiary IRA, 401(k)/403(b), SIMPLE plan, etc.). The process then moves to an enter client information step 150 using a screen which is illustrated in FIG. 8.

In the enter client information step 150, the agent 56 views a screen like the one shown in FIG. 8, and enters information including the customer's name, address, date of birth, social security number, etc. Typically, this information is entered by the agent 56 during a meeting or telephone conference with the customer 54. The owner display shown in FIG. 8 includes information on a joint owner, but can alternately include information on an annuitant or information on a beneficiary. Following entry of ownership information in the enter client information step 150, the process next moves to a determine suitability step 152.

In the determine suitability step 152, the agent 56 views a screen like the one shown in FIG. 9, and enters information which is directed toward ensuring that the annuity or other financial product is appropriate for the customer. For new accounts, this information is also required by Federal laws such as the Customer Identification and Verification (CIP) Requirements of the Patriot Act. Typically, this information is also entered by the agent 56 during a meeting or telephone conference with the customer 54. An error message will appear if any of the required information is missing or invalid. Both during this step and at other points during the entry of information by the agent 56, the sales assistant system 74 may optionally provide an indication to the agent 56 regarding any errors made in the entry of information by the agent in real time. Following completion of the information in the determine suitability step 152, the process then moves to a select product step 154.

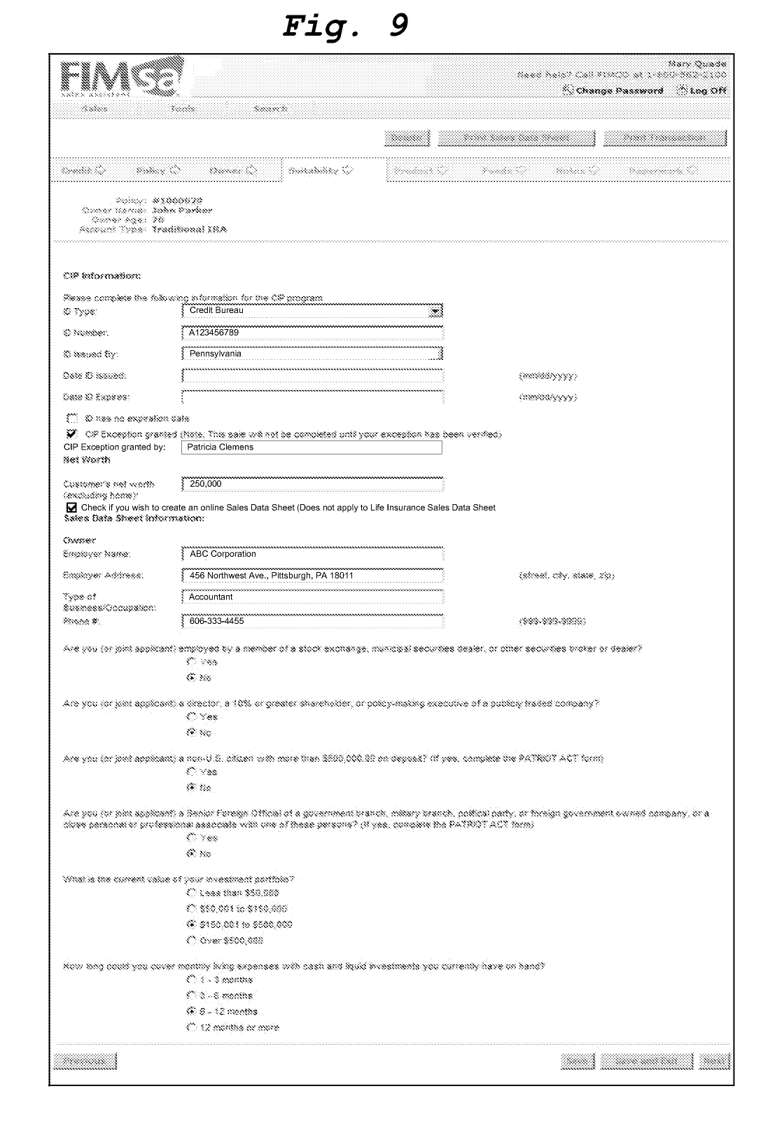

In the select product step 154, the agent 56 views a screen like the one shown in FIG. 10, and enters information which is directed toward the selection of the annuity or other financial product. Typically, the product carrier is selected first, followed by the product family and the product plan. In the preferred embodiment, only financial products which are appropriate for the particular customer are shown (for example, based on the customer's age, certain financial products may not be available). Following completion of the information in the select product step 154, the process then moves to an enter policy information step 156.

In the enter policy information step 156, the agent 56 views a screen like the one shown in FIG. 11, and enters information which is directed toward the rates of the policy as well as being generally directed toward the customer's investment information and strategy. The rate information may be provided by the rate information database 98 (illustrated in FIG. 1) to the sales assistant system 74 (also illustrated in FIG. 1). It will be appreciated by those skilled in the art that the requested information relating to the customer's investment information and strategy will vary according to the annuity or other financial product which is being purchased. Following completion of the enter policy information step 156, the process then moves to an enter funds information step 158.

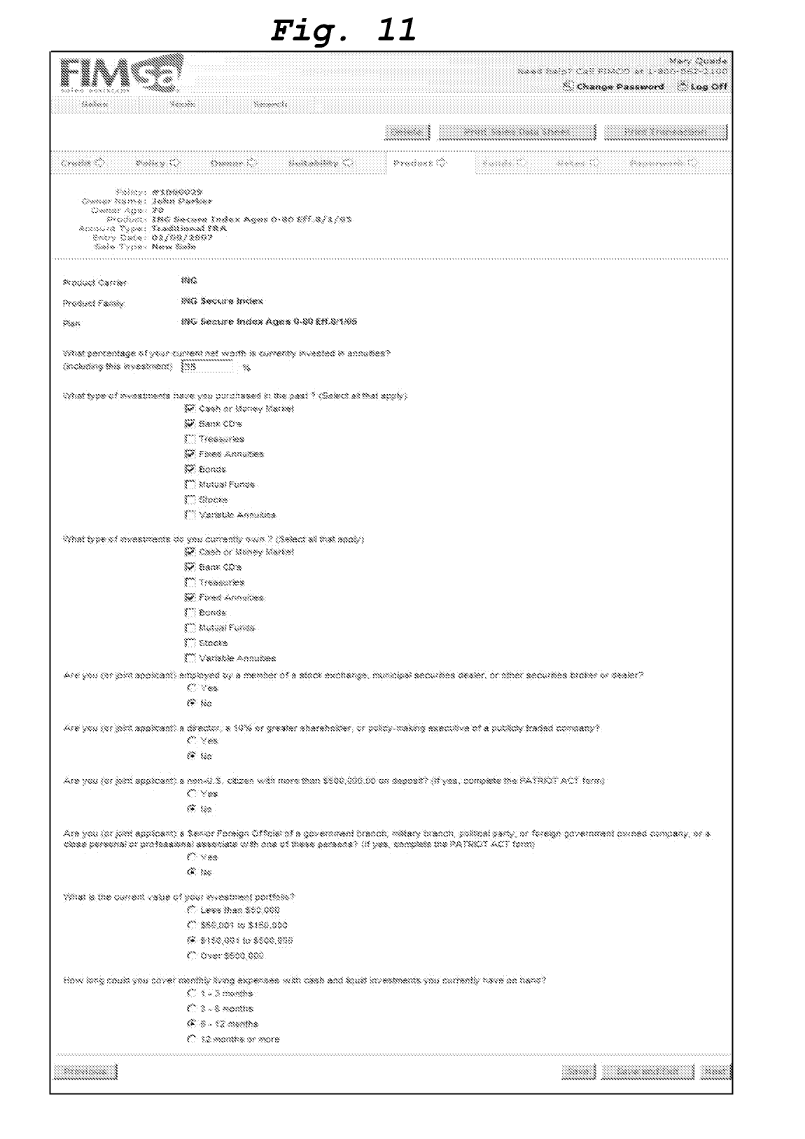

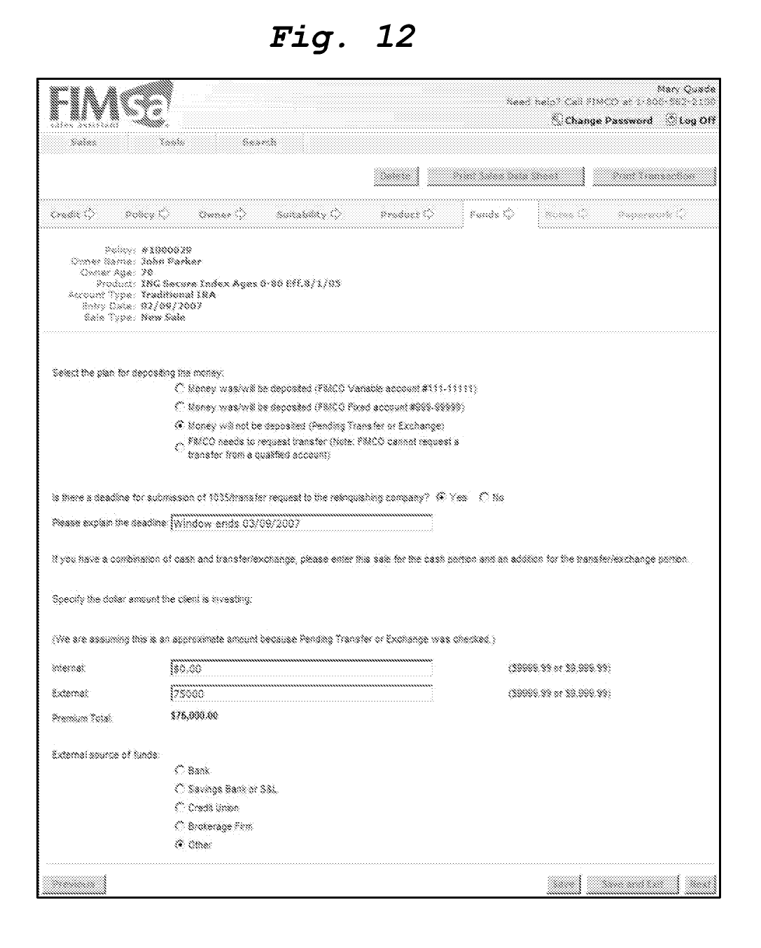

In the enter funds information step 158, the agent 56 views a screen of which one example is shown in FIG. 12, and enters information which indicates the source of the funds for the annuity or other financial product. It will be appreciated that the screen will vary considerably in appearance based upon its context, due to the type of financial product and other sale-related information. The screen shown in FIG. 12 includes logic which is dynamically used to determine which questions will appear on the actual screen which an agent 56 would view during the enter funds information step 158. Additional screens would be used as needed to obtain additional information. The process moves to an enter notes step 160 where the agent 56 can enter any notes about the sale, the customer, etc. using a screen such as the one shown in FIG. 14.

The process next moves to a sale complete/check policy step 162 in which the sales assistant system 74 will run a complete check of the information entered to determine whether the information for purchasing the new annuity or other financial product is “in good order.” Prior to describing that process in more detail, it is necessary to return for the moment to the new sale determination step 146. If, on the other hand, the agent 56 indicates in the new sale determination step 146 that the sale of an annuity or other financial product is an addition to an existing policy, the agent 56 may also specify information relating to a previous sale such as the policy number if known, the state where the policy was written, and the account type. Following entry of this information, the process moves to a locate client step 164.

In the locate client step 164, the agent 56 views a screen like the one shown in FIG. 13, and verifies information which is directed toward locating the client for whom previous sale activity has occurred. Once the client in question has been located, the process can move to the determine suitability step 152 to sell an additional annuity or other financial product or an addition to an existing annuity to the repeat customer. Alternatively, the process can move to the edit policy information step 128 to add additional information to complete an as yet incomplete sale. From the determine suitability step 152 or the edit policy information step 128, the sale information, when completed, allows the process to move to the sale complete/check policy step 162 for a determination of whether the now-completed information for purchasing the new annuity or other financial product is “in good order.”

From the sale complete/check policy step 162, the process moves to a passed check determination step 166 in which it is determined whether or not the review determined that the sale information was “in good order.” If it is determined that the sale information was not “in good order,” then the process returns to the edit policy information step 128 where the agent 56 may edit the sale information to correct the errors, which will in the preferred embodiment be highlighted for the benefit of the agent 56. If, on the other hand, it is determined in the passed check determination step 164 that the sale information is “in good order,” the process moves instead to a send sale step 166.

In the send sale step 168, the information for the purchase of the annuity or other financial product is sent by the sales assistant system 74 (shown in FIG. 1) to the financial product provider 52 (also shown in FIG. 1). (Since most financial product providers still require paper, paper copies may be printed and signed and sent to the financial product providers to comply with their formalities requirements.) The annuity or other financial product is then sold by the financial product provider 52 in a purchase annuity step 170. The funding of the annuity or other financial product has been executed according to the information entered by the agent 56, who completes his/her use of the web-accessible financial product sales assistance system and method of the present invention and the process then terminates in a process completion step 172. Note that in one embodiment, the agent 56 can enter any additional notes using a screen such as the one shown in FIG. 14.

Following the sale of the annuity or other financial product, the financial product provider 52 who sold the annuity or other financial product compensates the bank or agency client 58 employing the agent 56, with the bank or agency client 58 then compensating the operators of the sales assistant system 74 for their services. Since the sales assistant system 74 automatically checks all sales orders of annuities and other financial products prior to sending them to the financial product providers 52, it will be appreciated that all orders submitted to the financial product providers 52 are “in good order.” Finally, the agents 56 are automatically prompted to correct the sales information, and the sales assistant system 74 is far less labor-intensive than is the operation of the call center system 62.

Now that the overall process has been described, the sale complete/check policy step 160 shall be described in further detail. It should be noted that in one embodiment, the web-accessible financial product sales assistance system and method assigns the agents 56, the bank or agency client 58, and the financial product providers 52 a user level for access. The user levels include, for example, a retailer user level, a team leader user level, an affiliate user level, a management user level, a reviewer user level, and a back office user level. The retailer user level allows a user to enter a sales transaction for himself. The team leader user level allows a user to enter a sales transaction for herself and see the sales of her team. The affiliate user level allows a user to view sales transactions in a region. The management user level allows a user to view sales transactions for his company. The reviewer user level provides the same access as the management user level with the additional capability of taking action on sales transactions as will be discussed in more detail below. The back office user level allows a user to enter a sales transaction for any agents 56 or bank or agency clients 58 in the sales assistant system(s) 74. This user level provides the ability to search for sales not yet entered and to enter data for an untrained person, which in turn trains the untrained person who is watching the data being entered.

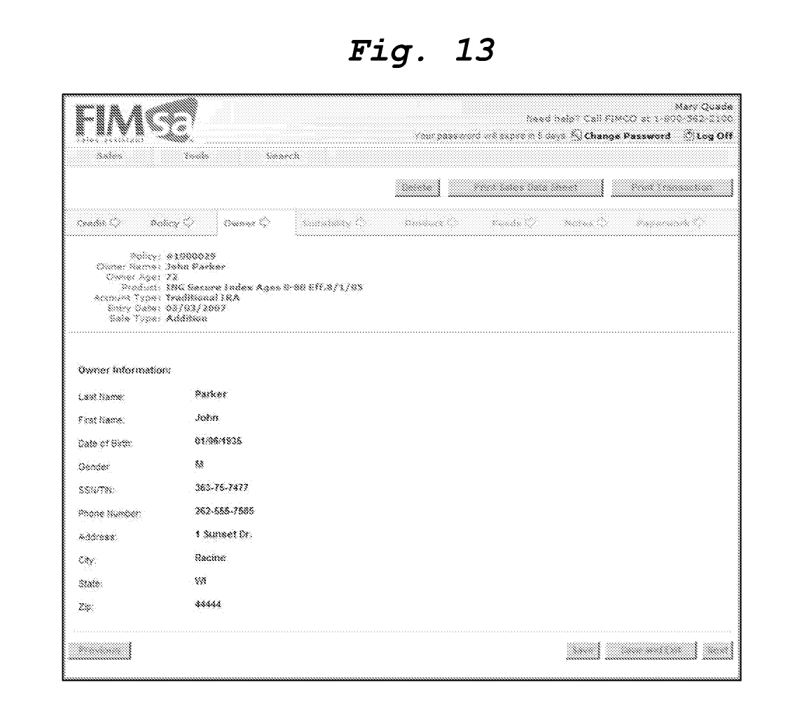

As previously indicated, the sales assistant system 74 will run a complete check of the information entered to determine whether the information for purchasing the new annuity or other financial product is “in good order.” One of the checks that is done is to check the information against one or more sets of rules provided by the financial providers 52 and/or the bank or agency client 58. Distributors, such as the bank or agency client 58, are provided the ability to create rules using a principal review dashboard, a screen of which one example is shown in FIG. 15. The principal review dashboard is part of the sales assistant system 74. Users with an access level of principal reviewer or back office are provided access to the principal review dashboard.

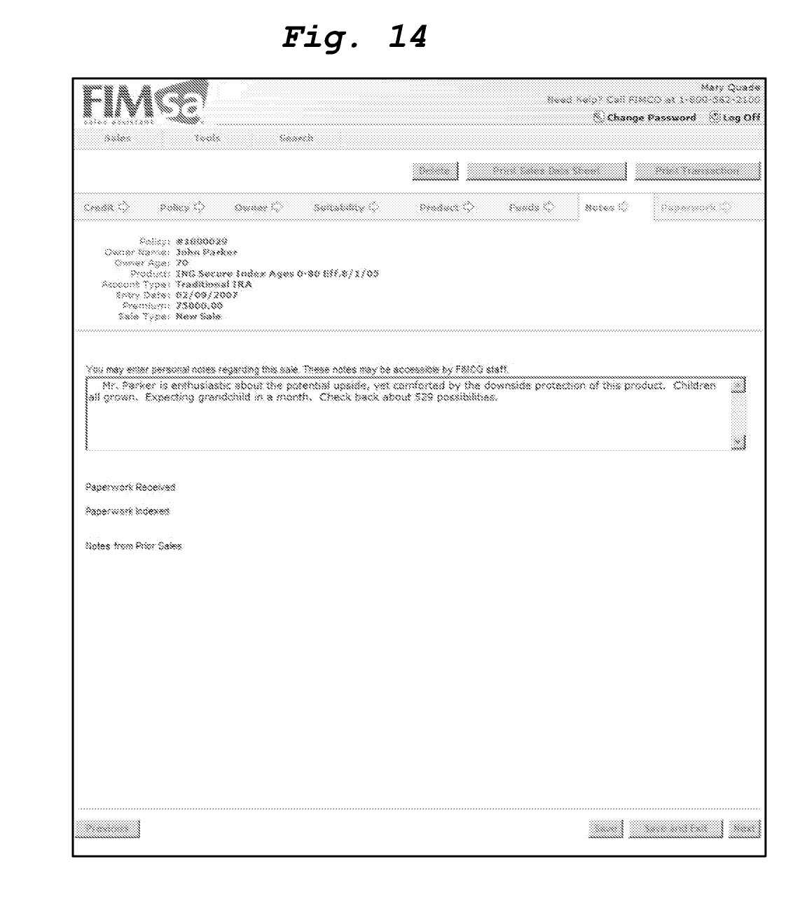

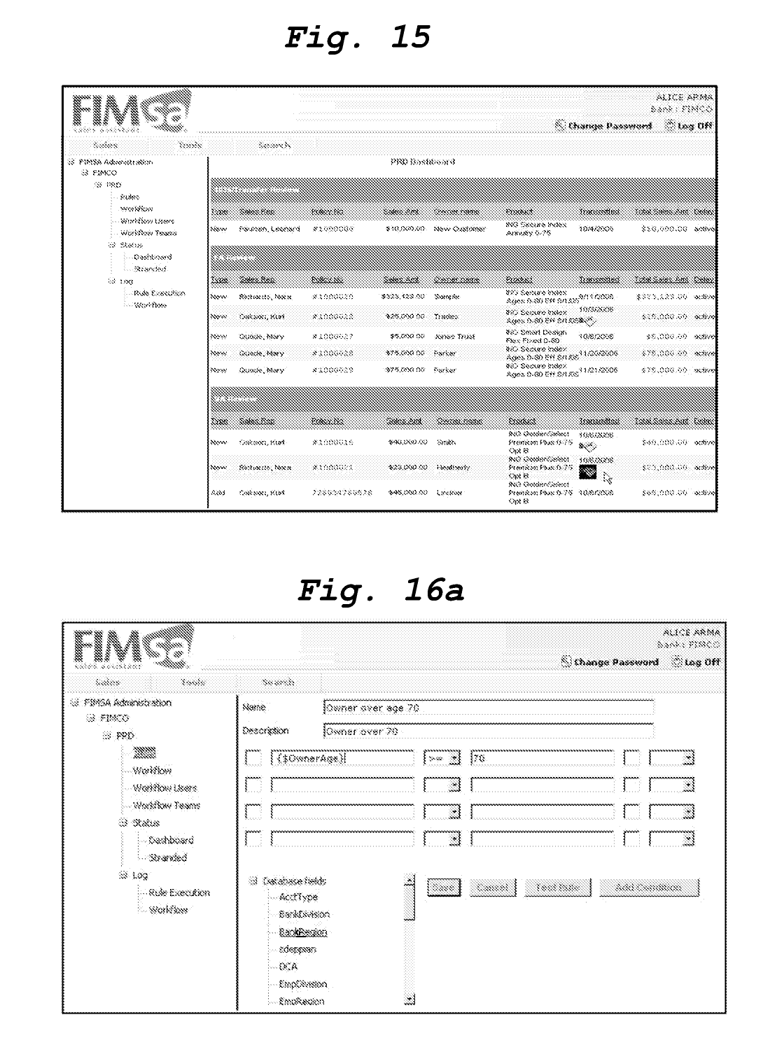

The principal review dashboard allows a user having the appropriate access (e.g., a back office user level) to create and edit rules (see FIGS. 16a and 16b for an example of screens for creating a rule), add users (see FIG. 17 for an example) and assign users to teams, change the teams on which a user is assigned, and see workflow (i.e., transactions in the checking stage) and which review team or teams is assigned to review a transaction, and see what transactions are stranded. An example of when a transaction may be stranded is when a sales representative leaves his employer for another job, thereby leaving no one responsible for the sales transaction. Additionally, the principal review dashboard allows the user to see all rules a transaction was tested against and every action taken on a transaction.

The tools menu allows a user to run reports, manage users, obtain helpful hints about the dashboard, see FAQs (frequently asked questions) about the dashboard, and access a distributor's forms. For example, it is not uncommon for a distributor to get a request from an agency such as the NASD (National Association of Securities Dealers) for anywhere from a few files to thousands of files. Even if the search criteria would be incorrect, a distributor would be able to fulfill that obligation by clearing it through the principal review dashboard and identifying all those transactions and then sending them on to the agency in a very short period of time. The reports module functionality is built on an underlying SQL server's Reporting Services technology and it takes into consideration the hierarchy and security (e.g., access levels) that is built into the system and it builds reports quickly for the end users based on their level of access. Reviewer users have reports for them to use that would only be visible for them, program management have a different series of reports etc., down to the representative level where users have blotters that they can run for themselves or the team leader level where users can run a blotter for themselves or anyone in their team.

The forms module provides a carrier's or distributor's suitability form. In one embodiment, there are four different suitability forms based on the type of business being entered. The forms provide PDF (Portable Document Format) files of a carrier's applications and the supplemental forms associated with applications. Some carriers also provide post sale service forms and paperwork to allow address changes, allocation changes, etc. to be made.

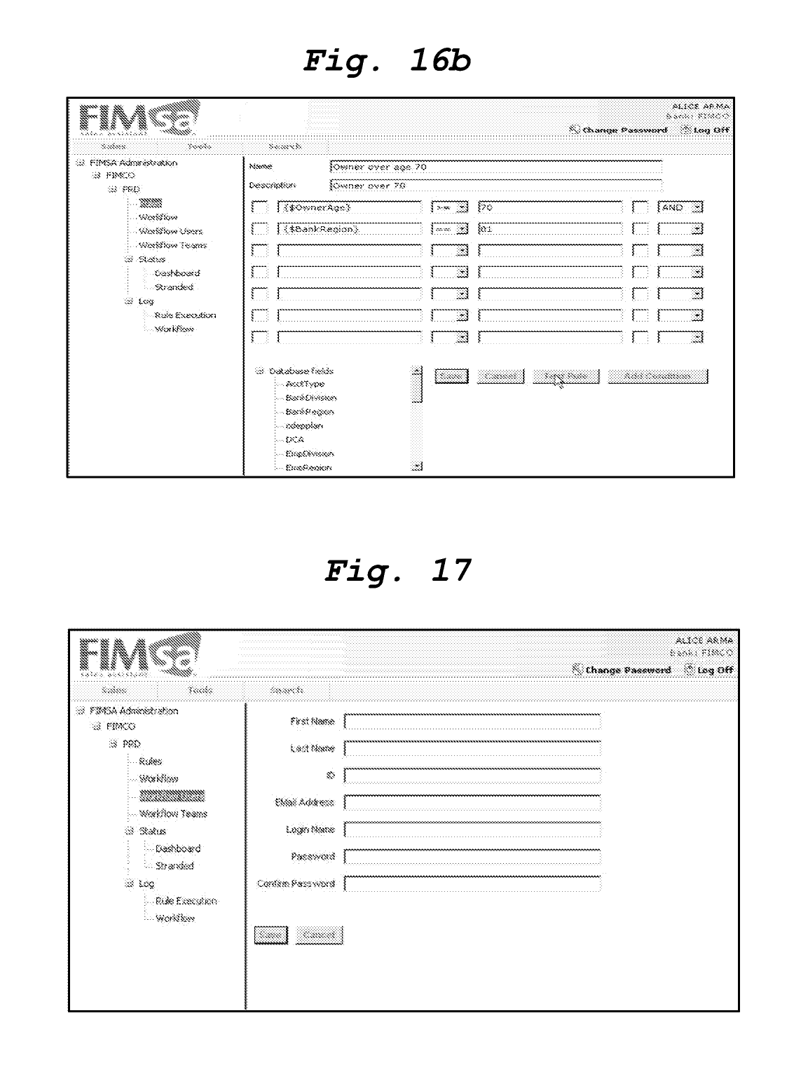

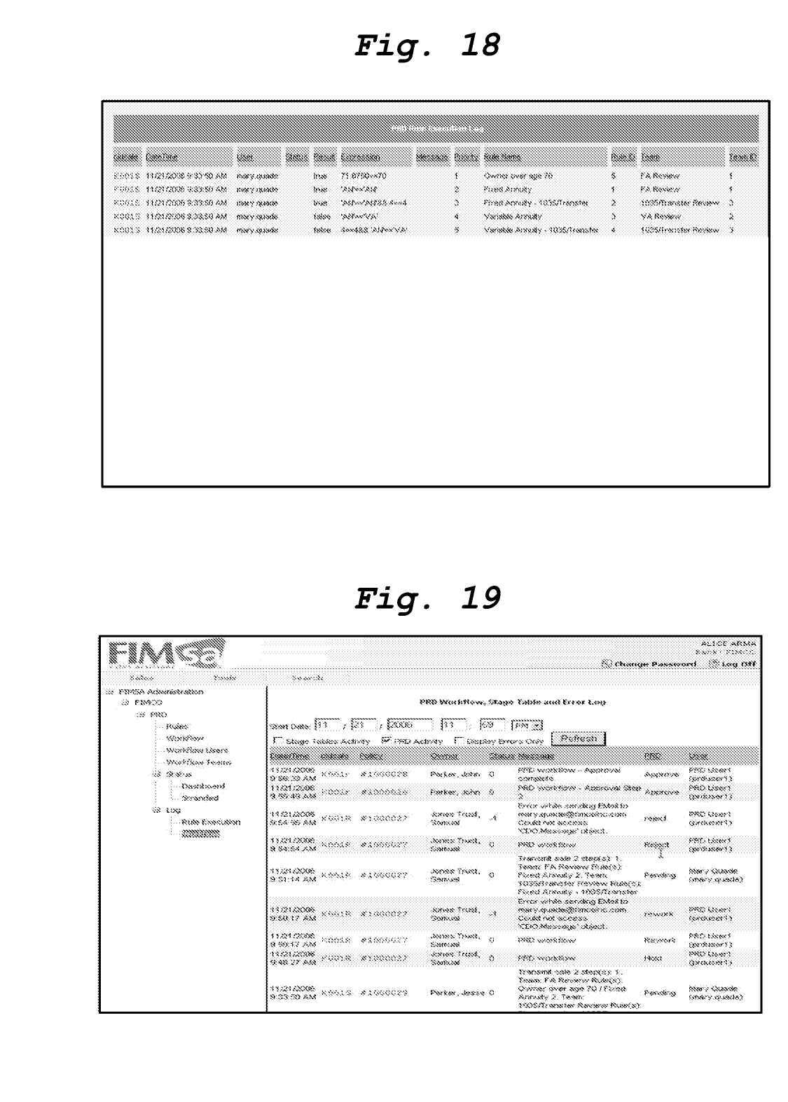

The log section provides other tools that can be used. One tool is the rule execution log. This log will generate a record for every transaction that gets transmitted into the system. Turning to FIG. 18, an example of a log for a transaction is shown that was entered. One can see all the rules that this transaction was tested against and see the results for each rule. The rule execution log also indicates which teams that a transaction will be going to flow through to and how it is evaluated. In one embodiment, once a rule is created and work loads change, the rule created will process immediately so any transactions coming through after that will test against all the rules that are present at that time and not the rules previously in force.

Another tool that can be used is the work flow log. As each transaction is being worked through the principal review dashboard, every action that is taken on a transaction will create an entry in the work flow log. An example of a work flow log is shown in FIG. 19. One can see sales that were being worked on, where a sales was put on hold and sent for rework, where it got reworked by the sales representative, became pending and transmitted again pending, then it got rejected to the representative. A user can run queries based on the policy number and see all of the steps, all of the actions that were taken on a policy by policy basis. Using the data and the rule execution data, one can build reports to give statistical analysis on what is being processed by a particular review group.

A reviewer uses the principal review dashboard to review transactions and can tag a transaction with an approve status, a reject status, a rework status, or a hold status. The status is communicated to the sales representative when the representative logs onto the system. Each reviewer is generally a member of one or more teams that review specific types of transactions. For example, there can be a team for fixed annuities, a team for variable annuities, a team for 1035 reviews, etc. A transaction could be review by more than one team.

Turning now to FIG. 20, the overall steps a reviewer takes in one embodiment are shown. In step 200, the reviewer selects a transaction for review. The reviewer determines if rework of the transaction is needed (step 202). If rework is needed, the reviewer creates a note and sends the transaction back to the representative (i.e., a user with a retailer access or team leader access) for review (step 204). An e-mail also gets sent to the representative and the representative's supervisor(s). The reviewer determines if the transaction should be rejected (step 206). If a transaction is rejected, the notice of the rejection is sent to the representative (step 208). An e-mail also gets sent to the representative and the representative's supervisor(s). If the reviewer determines that the transaction is acceptable, a check is made to determine if the transaction is to be reviewed by one or more other review teams (step 210). If the transaction is to be reviewed by another review team, the transaction is transferred to the next review team tasked to review the transaction (step 212). Each team performs steps 200 to 212. When a transaction is approved by all teams tasked to review the transaction, the paperwork, which is generally in electronic form, is submitted to the issuing carrier (step 214).

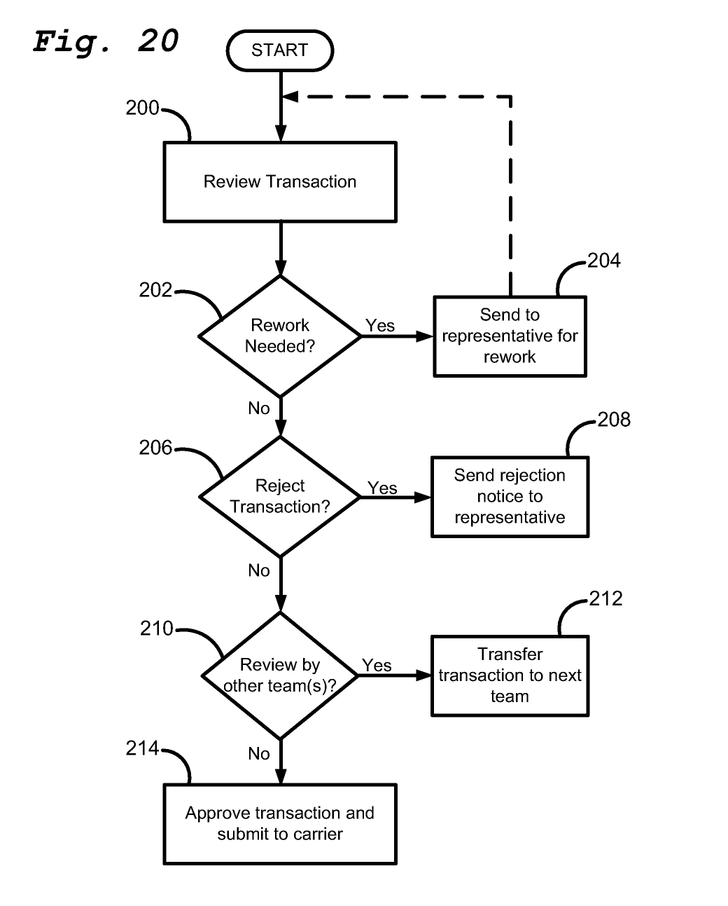

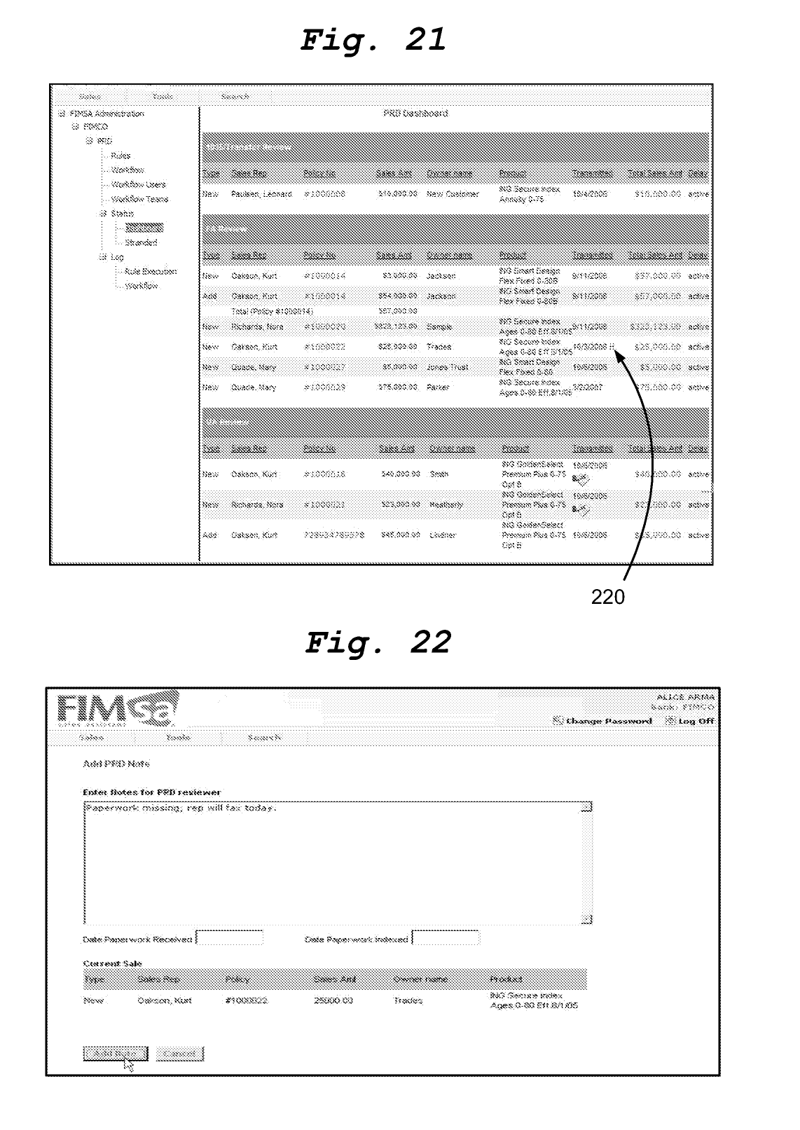

Once a reviewer selects a transaction for review, a visual indicator 220 is put on the transaction in the principal review dashboard to provide an indication that the transaction has been put on hold for review. An example of a visual indicator 220 is illustrated in FIG. 21. While FIG. 21 shows one form of visual indicator, it is noted that other shapes and/or characters may be used. Other reviewers can look at notes associated with the transaction to determine who put the transaction on hold. An example of adding a note is shown in FIGS. 22-23 where it can be seen that a reviewer with a user name of Alice Arma wrote a note indicating that paperwork for the transaction is missing and that the sales representative indicated it would be faxed on that day.

If there is any communication going back and forth from a reviewer to the representative and the reviewer entered a note about the communications into the system, a reviewer user or back office user would also see the note listed when they access the transaction. If a reviewer has decided that a representative should rework a transaction, the reviewer would create a note and send it back to the representative for rework. An example of a screen that a reviewer can use is shown in FIG. 24. This gives the reviewer an opportunity to send some notes back to the representative telling him what needs to be reworked or perhaps changed or if the representative needs to provide more information. Once a rework is selected, at least two things will happen. First the representative's In-Process Transaction Listing Log will be updated and when the representative logs into the system, he will see that the sale he transmitted that was pending PRD action now requires rework. The second thing it will do is it will send out an email message to the representative and the supervisor(s) with a hyperlink to the transaction letting him know that the sales transaction has been requested for rework. The representative can then click on the hyperlink, authenticate into the system and make changes to the sales transaction. Once a transaction is set for rework, it comes off of the dashboard.

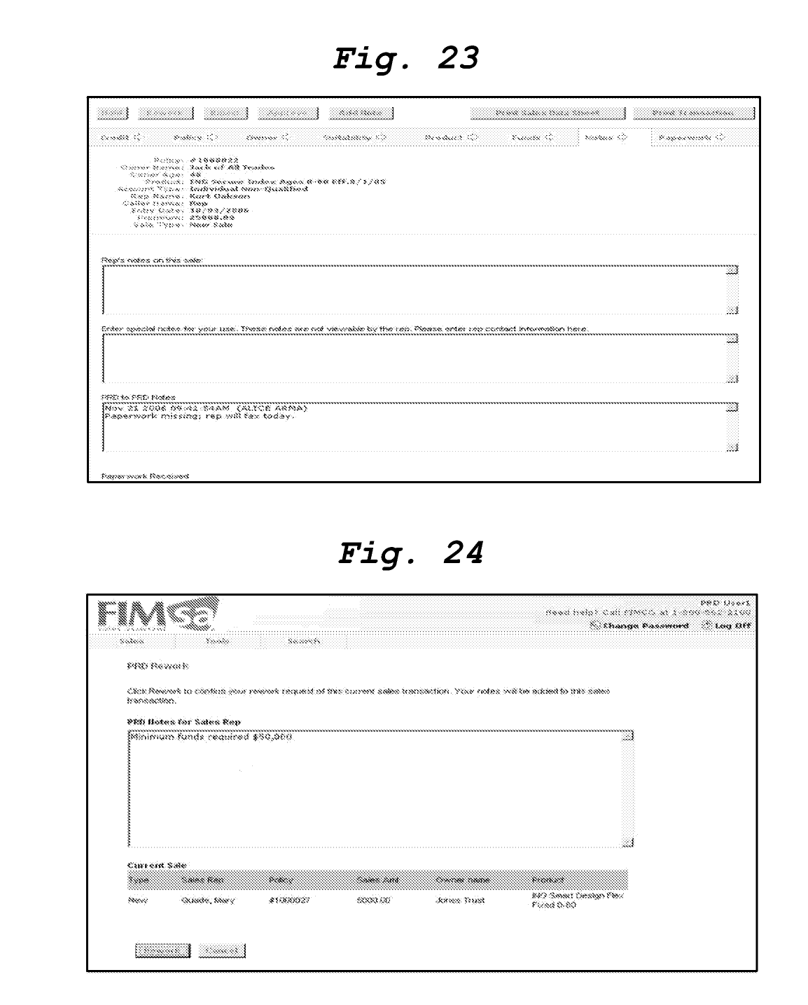

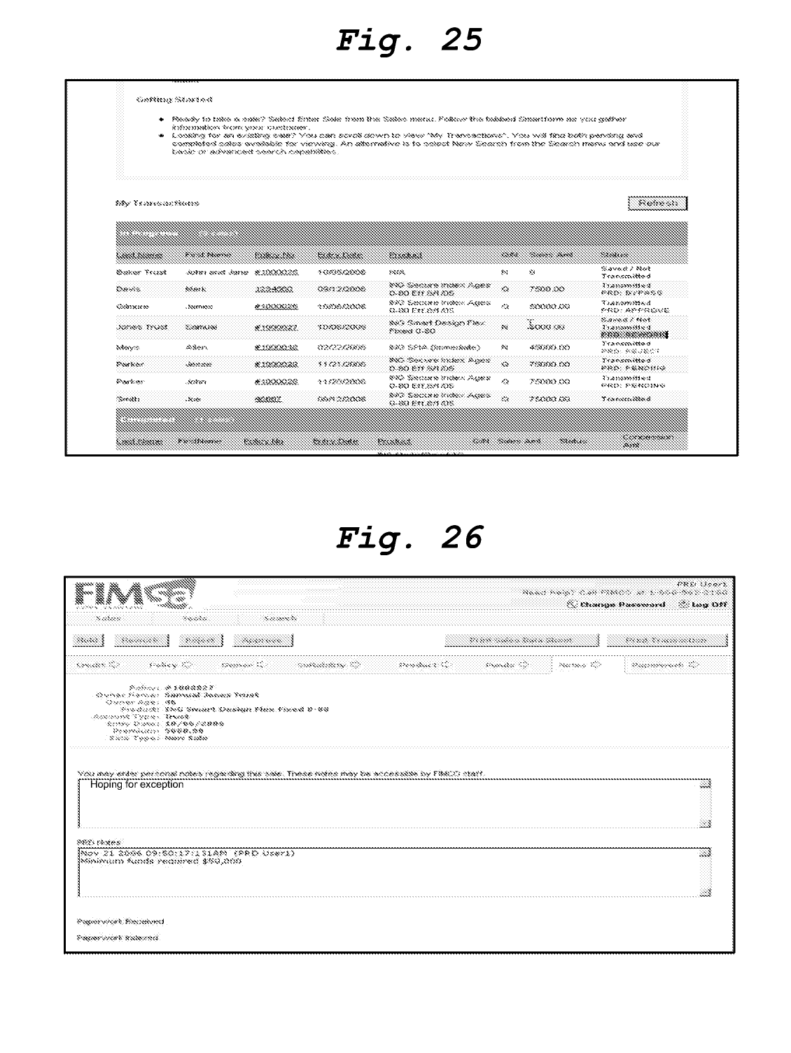

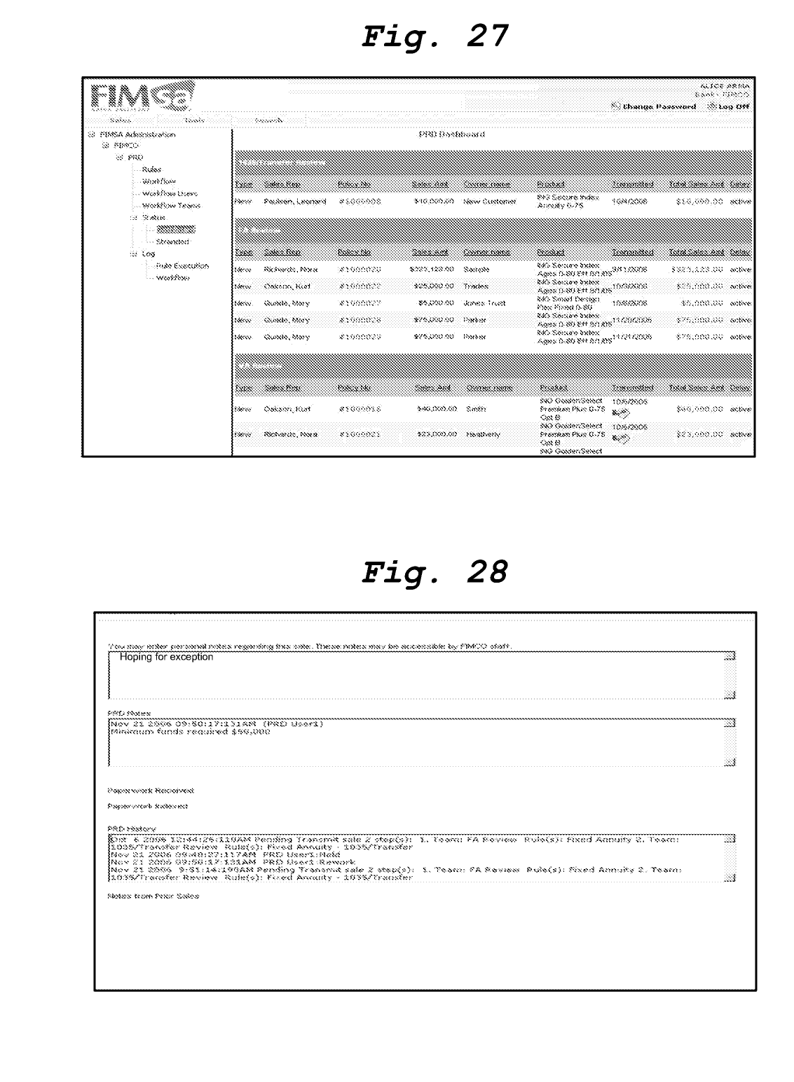

FIG. 25 provides an example of a screen that a representative sees and it can be seen that there is a sale that has been set for rework. The representative can look at it and go to the note tab and can see what the reviewer is telling the sales representative what is required/needed/etc. When a transaction is set for rework, this is the only time after it has been transmitted that a representative can go back and make changes to the transaction. The representative can make the changes or call for an exception to the policy rules. FIG. 26 provides an example of a representative asking for an exception and resubmitting the transaction. Once it has been submitted, the dashboard indicates the transaction is pending again (see FIG. 27).

In one embodiment, once a transaction gets transmitted and it is indicated that it is PRD pending, one of the things that happens is that it is put in a review queue before it actually can be seen on the principal review dashboard. This is done for two reasons. One reason is that there are some institutions that may ask for the ability to have some transaction types automatically approved as they go through the system with the concern that they did not want the representative to know that certain transactions are automatically approved while others had to stop and wait for review. The time delay gives the representative the sense that somebody is still looking at it and some action is being taken.

The other reason for the delay is to facilitate if there is more than one funding method for a particular policy. For example, if a representative was entering in a sale that was part 1035 and part new money, the representative would enter in two different transactions in one embodiment of the system. In an alternative embodiment, only one transaction is entered. In order to make two entries visible for the overall transaction and apparent for the reviewers as they are using the system, the time delay is provided. Building in the time delay provides time for both of the entries to be entered in the system and when a reviewer looks at the dashboard, she sees them lumped together with a total column listing what the full amount is. A typical time delay would be 60 minutes to 24 hours, depending on what the institution preferred.

When a reviewer selects a transaction for review after it has been reworked, the reviewer can see the notes from the previous reviewer, any notes the representative has provided, and the history of every action taken with respect to the transaction. FIG. 28 provides an example of the notes and history. A reviewer can see that the representative was hoping for an exception, the notes that the initial reviewer initially set, and the history of every action taken. This provides the benefit of recording an audit trail in a memo field on the work flow for each transaction as it goes through the system. In the example shown in FIG. 28, it can be seen that on October 6 it was transmitted, put on hold on November 21 and submitted for rework. After the representative resubmitted it, the transaction was tested again against all the rules. Note that it is tested against the rules that were in the system on November 21, which may not be the same rules that existed on October 6.

If a transaction is rejected using the reject button (see FIG. 23), the system provides similar functionality as the rework. A reviewer can enter a note back to the representative (see FIG. 29 for an example of a reject screen) and the system will update the dashboard and generate an email for the representative to inform her that the transaction was rejected (see FIG. 25 that shows a rejection in the representative's my transactions screen) and the transaction is taken off the dashboard.

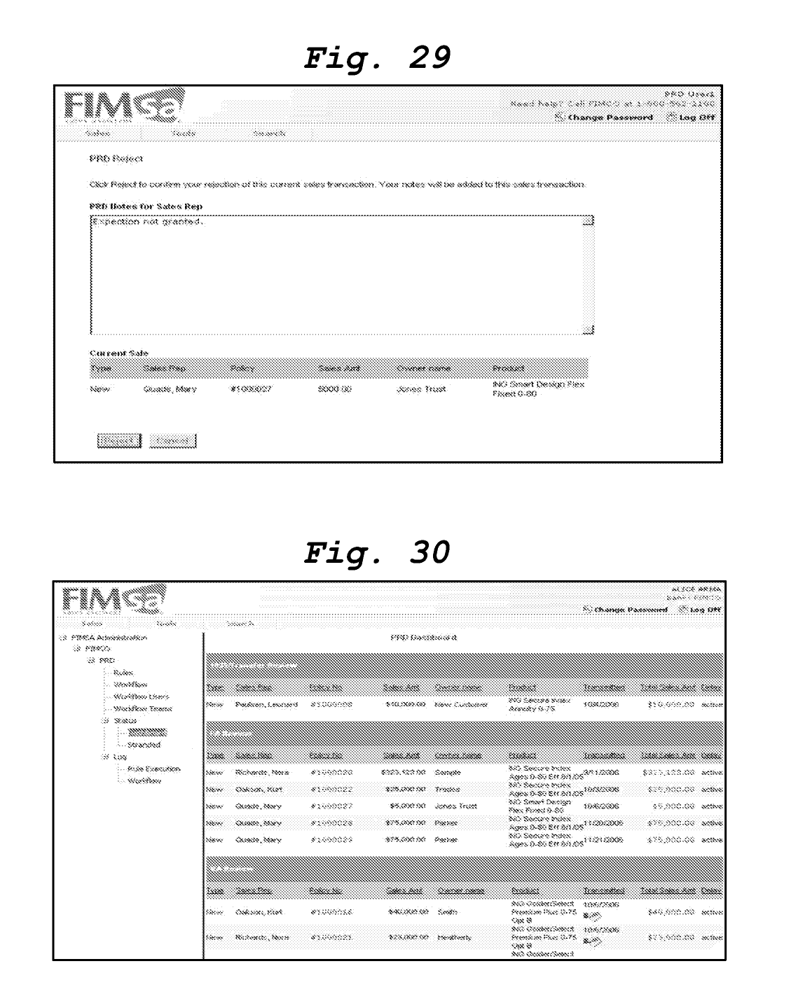

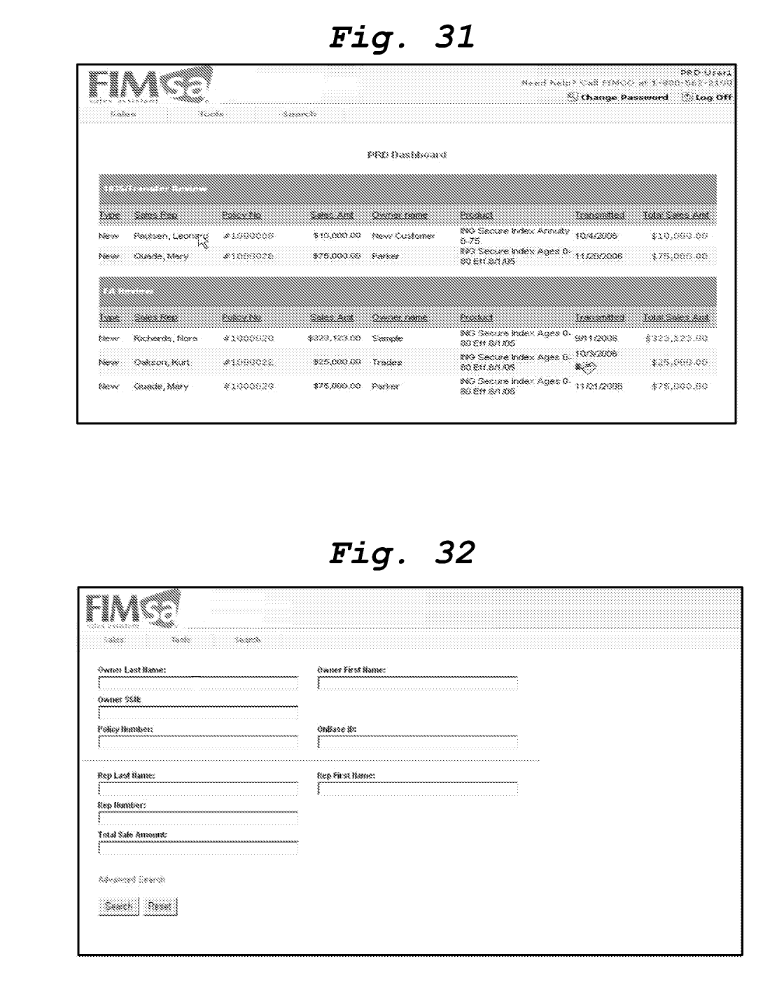

Note that if more than one team is to review a transaction, it must be approved by both teams. An example of this can be seen in FIGS. 30 and 31. In FIG. 30, policy number 1000028 is to be evaluated by the fixed annuity team and then after that to the 1035 transfer team. When the fixed annuity team approves it via selection of the approve button, the transaction gets transferred off the fixed annuity team and onto the 1035 transfer team (see FIG. 31).

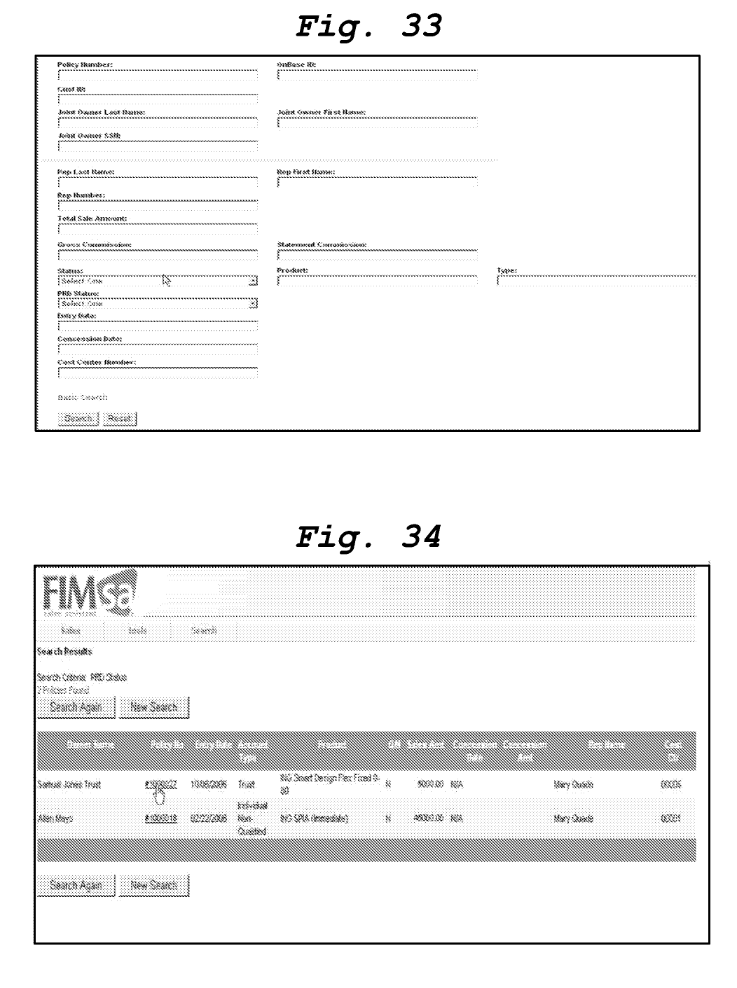

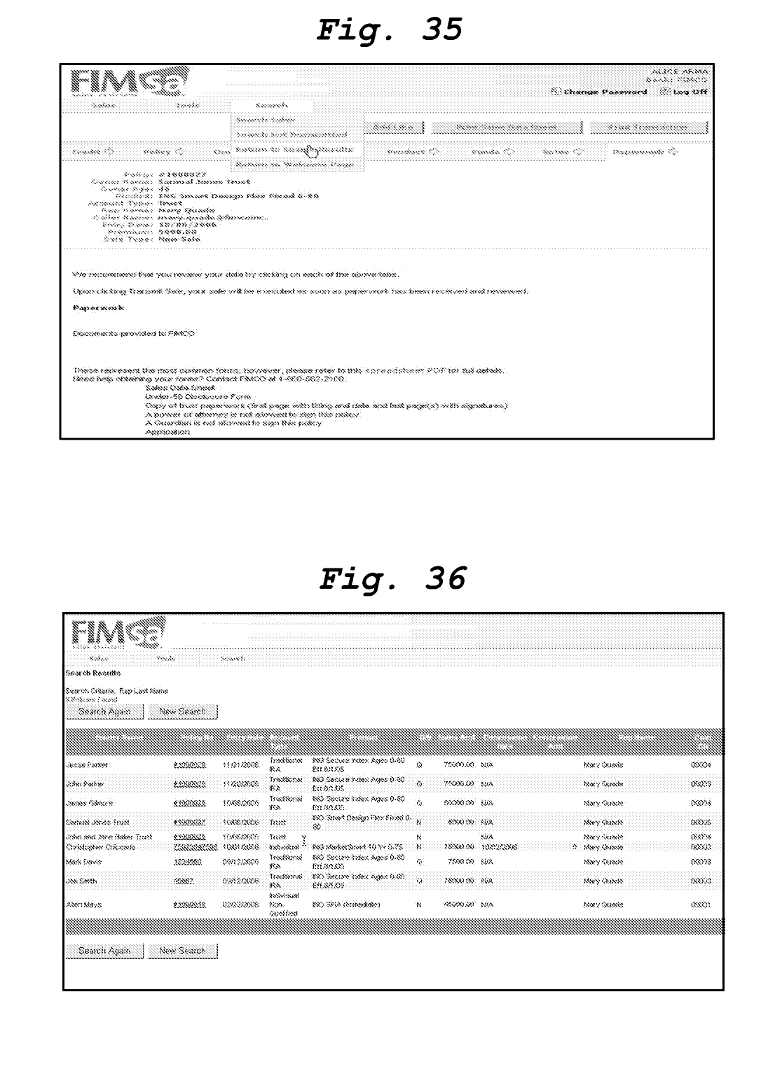

Another tool that can be used is the search function. When representatives initially log into the system, they see their “my transaction area” for transactions within a given period of time (i.e. monthly, quarterly, etc.). The search function allows a representative to search her entire book of business. A search can be run on the representative's own name, on the client, policy number, etc. An example of a basic search screen is shown in FIG. 32. An advanced search capability allows a user to enter in date ranges and other search criteria. An example of some of the advanced search criteria is shown in FIG. 33. For example, if a bank's management wanted to run a report or run a search on how many sales have been rejected for a period of time, they can do that kind of a search. Once the search results are brought up, a user can click on the policy number and the system will bring up the details for the policy. An example of search results is shown in FIG. 34. If the particular policy number selected wasn't the one wanted, a user can return to the initial search results (see FIG. 35). This is helpful when a user is running large searches or complex searches. The user does not have to take the time to run the search again. Instead, the user returns to her initial search results. FIG. 36 shows the results when a search is made on a representative's last name. The search function preserves security access. So, for example, if a user was logged in with limited access and searched for a different representative and did not have access to that representative's information, a search would return no results.

In order for the reviewer (and back office) to submit documents to the carrier, a copy of the signed paperwork is generally needed. When a representative faxes or sends in documents, an imaging component converts the fax and documents into electronic records (e.g., images) that are integrated into the system. Users with the proper access level can access the images. Representatives will always have electronic access to their customer files rather than by requesting a faxed paper copy or searching through their own files for copies. The imaging component additionally serves as an added level of safekeeping for records. Some carriers allow electronic signatures to be used. In such instances, the documents can be submitted with the electronic signature and thereby eliminate the need to fax a copy of signed paperwork in order to submit documents to the carrier.

It is noted that in the above description, the call center system 62 has call center employees located in the call center system 62. Teleworking, including long distance teleworking is becoming more and more widely used. It can be efficient and useful for companies as it allows staff and workers to communicate over a large distance, saving significant amounts of travel time and cost. In one embodiment, the call center system 62 provides a portal so that users can access the call center system 62 from anywhere using the Internet and the like. Additionally, some carriers allow customers 54 to use the sales assistant system to track their transactions.

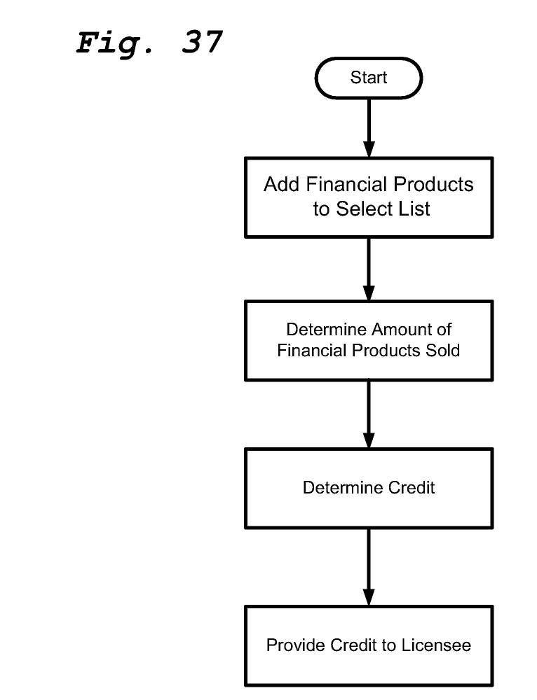

As previously indicated, the banks or agency clients 58 have selling agreements 60 with the financial product providers 52. Many banks/agency clients have a select number of annuities and other financial products that their agents 56 offer for sale. To further encourage the banks/agency clients 58 to use the present invention, a financial product provider 52 that licenses the present invention to the banks/agency clients 58 can provide a credit to the license fee if the bank/agency client 58 adds and sells the annuities and other financial products provided by the financial product provider 52. Turning now to FIG. 37, the products provided by the financial product provider are added to the list of products sold by the bank/agency client 58 if the products are not already on the list of products sold by the bank/agency client 58. For example, if the bank/agency client 58 provides a list of preferred products that their agents 56 are encouraged to offer for sale, the products sold by the financial provider 52 are added to the list and the agents are encouraged to buy the products from the financial provider 52. The amount of products provided by the financial product provider 52 that are sold are determined. Based upon that amount, the credit from the royalty payment(s) is determined and credited to the bank/agency 58. For example, if the bank/agency 58 sells products on the list, a predetermined basis point credit is provided to the next royalty payment due from the bank/agency 58. Alternatively, other ways of determining the credit may be used. For example, a fixed credit amount may be used, a sliding credit amount may be used, etc.

It may therefore be appreciated from the above detailed description of the present invention that it provides a web-accessible financial product sales assistance system and method that provides a service to agents of banks and agencies selling annuities and other similar financial products that is similar to the service provided by financial transaction solution providers call centers to place orders for the annuities and other similar financial products “in good order,” but more efficiently and at a lower cost. The web-accessible financial product sales assistance system and method of the present invention uses the Internet to provide a web-accessible financial product sales assistance system and method to perform the function currently performed by call center employees. The web-accessible financial product sales assistance system and method of the present invention is also capable of being integrated with an existing call center operation to service agents of banks and agencies which desire to continue using a call center at least in part.

The web-accessible financial product sales assistance system and method of the present invention is capable of working with any and all of the wide variety of annuities and like financial products available. The web-accessible financial product sales assistance system and method of the present invention is simple to use by agents who are employees of the banks and agencies selling annuities and other similar financial products. The web-accessible financial product sales assistance system and method of the present invention maximizes efficiency and minimizes cost in the selling and ordering of annuities and other similar financial products.

The web-accessible financial product sales assistance system and method of the present invention is relatively straightforward to implement by a financial transaction solution provider, and provides agents of banks or agencies selling annuities and other similar financial products with a highly reliable operation which is always available. The web-accessible financial product sales assistance system and method is as economically beneficial as possible to its bank and agency customers to enhance its market appeal and to thereby afford it the broadest possible market. Finally, all of the aforementioned advantages and objectives of the web-accessible financial product sales assistance system and method are achieved without incurring any substantial relative disadvantage.

Although the foregoing description of the web-accessible financial product sales assistance system and method of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A computer-readable medium having computer executable instructions for assisting agents in the sales of financial products offered by financial product providers to customers, the computer executable instructions, when executed, performing the steps comprising:
selectively allowing an agent to access a first computer accessing information relating to financial products offered by a plurality of financial product providers with a second computer located remotely from the first computer;
based upon selection of a particular financial product for sale to a customer by the agent, prompting the agent to enter additional information needed to process a transaction of the particular financial product to the customer;
if the transaction requires review:
placing the transaction in a queue of a team assigned to review the information;
if a team member determines that rework of the transaction is needed, sending the transaction back to the agent for rework;
if the team member determines that the transaction is to be rejected, sending notice of the rejection to the agent;
if the team member approves the transaction, placing the sale request with the financial product provider selling the particular financial product;
if the transaction does not require review:
automatically checking to determine whether the information provided by the agent regarding the sale of the particular financial product to the customer is sufficient to place the sale request “in good order;”
if the checking step determines that the information provided by the agent regarding the sale of the particular financial product to the customer is not sufficient to place the sale request “in good order,” automatically prompting the agent to make appropriate changes to the information provided by the agent regarding the sale of the particular financial product to the customer to place the sale request “in good order;” and
if the checking step determines that the information provided by the agent regarding the sale of the particular financial product to the customer is sufficient to place the sale request “in good order,” placing the sale request with the financial product provider selling the particular financial product.

2. The computer-readable medium of claim 1 having further computer-executed instructions that when executed, perform the steps of:
determining if the transaction is to be reviewed by another team; and
if the transaction is to be reviewed by another team, placing the transaction to a queue of the other team after the transaction has been approved by the team member.

3. The computer-readable medium of claim 2 having further computer-executed instructions, that when executed, perform the steps of:
if a team member of the other team determines that rework of the transaction is needed, sending the transaction back to the agent for rework;
if the team member of the other team determines that the transaction is to be rejected, sending notice of the rejection to the agent;
if the team member of the other team approves the transaction, placing the sale request with the financial product provider selling the particular financial product;

4. The computer-readable medium of claim 1 having further computer-executable instructions, that when executed, perform the step of placing a visual indicator on a review screen when a team member selects the transaction to review, the visual indicator indicating that the transaction has been put on hold for review.

5. The computer-readable medium of claim 1 wherein the agent has a transaction log of pending transactions, the computer-readable medium having further computer-executable instructions, that when executed, perform the step of updating the transaction log to indicate the transaction needs rework if the team member determines that rework of the transaction is needed.

6. The computer-readable medium of claim 1 wherein the agent has a transaction log of pending transactions, the computer-readable medium having further computer-executable instructions, that when executed, perform the step of updating the transaction log to indicate the transaction has been rejected if the team member determines that the transaction is to be rejected.

7. The computer-readable medium of claim 1 having further computer-executable instructions, that when executed, perform the steps of:
generating a message to inform the agent that the transaction has been rejected if the transaction has been rejected; and
generating a message to inform the agent that the transaction needs rework if the transaction needs rework.

8. The computer-readable medium of claim 1 wherein the step of automatically checking to determine whether the information provided by the agent regarding the sale of the particular financial product to the customer is sufficient to place the sale request “in good order” includes the step of testing the information against at least one rule.

9. The computer-readable medium of claim 1 wherein the financial products include annuities.

10. The computer-readable medium of claim 1 having further computer-executable instructions, that when executed, perform the step of putting the transaction in a review queue once the transaction has been submitted by the agent.

11. The computer-readable medium of claim 1 having further computer-executable instructions, that when executed, perform the step of creating an entry in a work flow log for every action that is taken on a transaction.

12. The computer-readable medium of claim 1 having further computer-executable instructions, that when executed, perform the step of creating a record for a transaction, the record listing all the rules in which the transaction was tested against, results from the rules, and which teams have reviewed the transaction.

13. The computer-readable medium of claim 1 having further computer-executable instructions, that when executed, perform the step of providing a dashboard that allows a user to create and edit rules, add users, assign users to teams, change the teams on which a user is assigned, see transactions in a review stage, see which review team or teams is assigned to review a transaction, and see what transactions are stranded.

14. The computer-readable medium of claim 13 having further computer-executable instructions, that when executed, perform the step of providing a tools menu on the dashboard that allows a user to run reports, manage users, obtain helpful hints about the dashboard, see FAQs (frequently asked questions) about the dashboard, and access a distributor's forms.

15. The computer-readable medium of claim 13 having further computer-executable instructions, that when executed, perform the step of providing a search function on the dashboard.

16. The computer-readable medium of claim 1 having further computer-executable instructions, that when executed, perform the step of converting signed and completed paperwork required by the financial product provider selling the particular financial product to an electronic version of the signed and completed paperwork.

17. The computer-readable medium of claim 1 wherein the computer readable medium is licensed to a licensee, the computer readable medium having further computer-executable instructions, that when executed, perform the steps of:
listing products provided by a financial product provider; and
determining an amount of the products provided by the financial product provider that are sold, whereby the financial product provider provides a credit to the licensee based upon the amount.

18. The computer-readable medium of claim 1 wherein the agent is an employee of a bank or an agency, and wherein the bank or agency has selling agreements with the financial product providers.

19. The computer-readable medium of claim 1 having further computer-executable instructions, that when executed, perform the step of allowing an agent to enter notes about the transaction.

20. The computer-readable medium of claim 1 having further computer-executable instructions, that when executed, perform the step of selectively allowing the customer to access a third computer to track a transaction of a particular financial product being sold to the customer.

21. A computer-readable medium having computer-executable instructions, that when executed, perform the step of providing a dashboard that allows a user to create and edit rules, add users, assign users to teams, change the teams on which a user is assigned, see transactions in a review stage, see which review team or teams is assigned to review a transaction, and see what transactions are stranded.

22. The computer-readable medium of claim 20 having further computer-executable instructions, that when executed, perform the step of providing a tools menu on the dashboard that allows a user to run reports, manage users, obtain helpful hints about the dashboard, see FAQs (frequently asked questions) about the dashboard, and access a distributor's forms.

23. The computer-readable medium of claim 21 having further computer-executable instructions, that when executed, perform the step of providing a search function on the dashboard.

24. A method for encouraging agents of a bank or agency selling annuities and other similar financial products to license from a financial service provider licensor and use an interactive web-accessible financial product sales assistant system that facilitates the sale of financial products such as annuities by providing prompts to agents accessing the system to obtain and enter all financial product sales information required by the providers of the financial products in order to place applications for the financial products in good order in the sales of financial products offered by financial product providers to customers, the method comprising the steps of:
listing products provided by the financial product provider licensee;
determining an amount of the products provided by the financial product provider licensor that are sold by the agents; and
providing a credit to the bank or agency based upon the amount.
